(19) United States
(12) Patent Application Publication
(10) Pub. No.: US 2025/0033001 A1
(43) Pub. Date: Jan. 30, 2025

(54) MEMBRANE HAVING A HIGH POROUS SOLID CONTENT

(71) Applicants: CENTRE NATIONAL DE LA RECHERCHE SCIENTIFIQUE, Paris (FR); MUSEUM NATIONAL D'HISTOIRE NATURELLE, Paris (FR); ECOLE NORMALE SUPERIEURE, Paris (FR); ECOLE SUPERIEURE DE PHYSIQUE ET DE CHIMIE INDUSTRIELLES DE LA VILLE DE PARIS, Paris (FR)

(72) Inventors: Pierre TIGNOL, Paris (FR); Anne-Laurence DUPONT, Paris (FR); Vanessa PIMENTA, Vitry-Sur-Seine (FR); Christian SERRE, Plaisir (FR); Bertrand LAVEDRINE, Paris (FR)

(21) Appl. No.: 18/844,023

(22) PCT Filed: Mar. 2, 2023
(86) PCT No.: PCT/FR2023/050281

§ 371 Date: Sep. 4, 2024

(30) Foreign Application Priority Data
Mar. 4, 2022 (FR) FR2201881

(51) Int. Cl. B01D 71/10; B01D 53/22; B01D 67/00; B01D 69/14

(52) U.S. Cl. CPC B01D 71/10; B01D 53/228; B01D 67/00042; B01D 69/141; B01D 2253/204; B01D 2257/708

(57) ABSTRACT

A method for preparing a porous membrane, comprising the following steps of:
a—preparing an aqueous mixture comprising a dispersion of fibres derived from an organic material in water, a solid organic binder and porous solid particles suspended in water;
b—leaving the obtained aqueous mixture comprising the fibres, the organic binder and the porous solid particles under stirring for at least 10 min at room temperature;
c—vacuum filtering the mixture and recovering a composite material; and
d—pressing said composite material obtained in step c—to form a porous membrane.

The present invention relates to the field of porous materials for trapping volatile organic compounds, also referred to as VOCs, or toxic gases such as nitrogen oxides (NOx), which are NO, or NO₂; more particularly, it relates to a method for preparing such a material and to a membrane including such a material.

### PRIOR ART

It is essential to be able to control the quality of the air in patrimonial institutions and in homes, or passage places, to allow guaranteeing hygiene and safety to goods and people. More particularly, the control of the content of certain compounds present in ambient air should be controlled, and numerous methods aim to capture pollutant volatile or gaseous compounds such as volatile organic compounds (VOCs), as described in the reference application [1], NOx, or other gases that might be harmful in a determined concentration in ambient air, such as CO₂.

Moreover, the materials primarily used for controlling the quality of air in a confined environment are activated charcoals and zeolites. These materials are not very selective for the adsorption of these pollutants and/or poorly regenerable, and more particularly in the context of the adsorption of VOCs, in the presence of water for zeolites. Hence, there is a real problem of efficiency of the adsorption of the VOCs in the presence of ambient humidity.

The adsorption of VOCs is known from beads or granules, sometimes included in foams, monoliths or textiles. In the case of the use of foams or textiles, the porous solid filling rates are low, and are not compatible with all uses, or lead to problems of adsorption efficiency, caused by the diffusion of the adsorbed materials, for example.

In the context of the invention, the term “filling rate” defines the percentage of pores occupied with respect to the total number of available pores.

It is known to resort to supports such as membranes or sheets for the adsorbent material, or to integrate the adsorbent material into such a support, in order to be able to use them, for example, as filters. Methods for manufacturing paper membranes with adsorbents already exist, however if the content of solid particles integrated into the membrane is too high, the mechanical stability of the cellulose matrix degrades. A product designed according to one of these manufacturing methods is commercially available under the reference “MicroChamber Paper™”, it is intended for the preservation of cultural goods or for the preservation of archive documents. Such a product is limited to a load of about 20% of zeolite, the remainder being cellulosic fibres and common additives for paper, its lack of efficiency being related to the excessively low adsorbent content (Zeolite) and its lack of specificity for the molecules actually adsorbed remains a drawback.

### DESCRIPTION OF THE INVENTION

The present invention aims to overcome the aforementioned drawbacks, by implementing a method for preparing a material integrating at least one type of fibres with adsorbent particles, which method should allow integrating these adsorbents in large contents in a paper membrane, beyond 50% by mass of the final mass of the paper, while preserving a good mechanical stability and VOCs capture properties identical to those of the pure adsorbent.

To this end, the present invention relates to a method for preparing a porous membrane comprising the following steps:
a—preparing an aqueous mixture comprising a dispersion of fibres derived from an organic material in water, a solid organic binder and porous solid particles suspended in water;
b—leaving the obtained aqueous mixture comprising the fibres, the organic binder and the porous solid particles under stirring for at least 10 min at room temperature;
c—vacuum filtering the mixture and recovering a composite material; and
d—pressing said composite material obtained in step c—to form a porous membrane.

Preferably, step a) of the method for preparing a porous membrane comprises the following sub-steps:
(i)—dispersing the fibres derived from an organic material in water;
(ii)—adding the solid organic binder; and
(iii)—adding the porous solid particles in suspension in water.

Preferably, and alternatively to the foregoing, step a) of the method for preparing a porous membrane comprises the following sub-steps:
(i)—preparing a suspension of porous solid particles in water;
(ii)—adding a dispersion of fibres derived from an organic material in water; and
(iii)—adding the solid organic binder.

In the context of the present invention, the term “solid organic binder” means a binder available in the form of a paste, a gel or a suspension in an aqueous mixture, or in suspension in water (in particular a colloidal suspension). In the context of the invention, the organic binder is used as a mixture in water at a weight content of 2 and 10% considered relative to the total weight of the binder. The term “solid organic binder” which will be used in the remainder of the description corresponds to a nanoscale structuring agent comprising nanocellulose, and preferably cellulose microfibrils, preferably with a length of 0.5 to 50 μm, more preferably from 4.5 to 35 μm, advantageously from 8 to 30 μm, or with a length of 11 to 25 μm. The length of the fibres is determined by observation with a microscope.

The term “nanoscale structuring agent” used in the context of the invention is used equivalently to the expression “nanoscale and/or microscale structuring agent” and refers to the nanoscale and/or microscale structuring of an object. This nanoscale structuring agent allows increasing the contact points (by weak interactions) within the composite (inter-binder interactions as well as with the porous solid particles and/or long fibres) and thus having a final composite with more cohesion (less pulverulent) and more rigid compared to a composite comprising only long cellulose fibres.

Preferably, the nanoscale structuring agent comprising cellulose microfibrils used in the method according to the invention is taken in a content of 2.5 to 40% relative to the total mass of the obtained porous membrane, and preferably from 5 to 35%, advantageously from 10 to 30%, or from 15 to 25%.

The term “nanocellulose” combines different categories of cellulose nanomaterials defined in 2011 in [2] by Klemm et al.: microfibrillated cellulose (MFC), nanocrystalline cellulose (NCC) and bacterial nanocellulose (BNC). The main difference lies in the mode of preparation thereof resulting subsequently in distinct dimensions of these nanomaterials. The BNC is obtained using aerobic bacteria, therefore from a biotechnological process while MFC and NCC will result from the destructuring of natural plant fibres. This microfibrillation is possible through an hydrolysis in an acid medium and/or a mechanical treatment (generally a homogeniser). The Technical Association of the Pulp and Paper Industry (also referred to by the English acronym TAPPI: “Technical Association of the Pulp and Paper Industry”) has standardised the classification of cellulosic nanomaterials according to their size: reference [3]. Thus, the microcrystalline cellulose (width: 10-15 μm, ratio L/D<2) and the microfibrillated cellulose or cellulose microfibril (MFC, length: 0.5-50 μm and width: 10-100 nm) rather have a nanostructuring function, while the cellulose nanocrystals (width: 3-10 nm, L/D>5) and the cellulose nanofibrils (width: 5-30 nm, L/D>50) rather pertain to the field of nano-objects.

In the context of the present invention, the “porous solid particles”, or “pore-forming agents”, are agents which confer the adsorption properties of pollutant volatile or gaseous compounds. Unexpectedly, the Inventors have demonstrated that such a method allowed combining several types of fibres, and preferably at least two types of cellulose fibres, and obtaining membranes comprising levels of porous solid particles in a membrane in some cases beyond 70% by mass of the final mass of the membrane, while preserving a good mechanical stability and an ability to capture VOCs equal to those of the starting porous solid particles, considered separately.

Depending on the porous solid particles used in the method according to the invention, these particles may be dispersed beforehand, preferably in an aqueous solvent, advantageously water and using an ultrasonic bath.

The term “composite material” within the meaning of the invention refers to a material comprising at least two immiscible components.

Preferably, the composite material obtained in the penultimate step is directly shaped while it is drawn under vacuum, for example by performing a vacuum drawing on a support with a water tube, or with a vacuum pump.

Advantageously, the fibres are biosourced fibres.

The term “biosourced” in the context of the invention defines elements derived from a renewable organic material (biomass), of plant or animal origin.

Preferably, the fibres are selected from among papermaking fibres of natural origin and plant fibres such as wood fibres, softwood fibres, coconut fibres, flax fibres, bamboo fibres, and cotton fibres, and more preferably the plant fibres include cellulose fibres. Advantageously, the fibres implemented in the method according to the invention are cellulose fibres, also so-called cellulosic fibres. A mechanical treatment, preferably grinding, and/or ultrasonic treatment, is advantageously carried out to improve the dispersion of said fibres. Preferably, the fibres used in the method according to the invention are taken in a content lower than or equal to 30% relative to the total mass of the obtained porous membrane, and preferably lower than or equal to 20%, advantageously lower than or equal to 10%, or lower than 5%.

Advantageously, the porous solid particles preferably include pores whose average size is 0.3 to 3 nm, and are selected from among at least one of the following particles: a zeolite particle, an activated charcoal particle, and a structured metal-organic compound particle, so-called MOF (Metal Organic Framework), which MOF includes polydentate chelating ligands. Advantageously, the porous solid particles are suspended in an aqueous solution comprising distilled water to form an aqueous suspension which is added to the initial mixture comprising the fibres and the organic binder solid.

In the context of the present invention, the term “porous solid” refers to a solid including porosity, which porosity being itself defined according to the definition of the IUPAC (cf. the reference [4]), which defines a porous solid like a solid having pores (cavities, interstices, channels) whose depth will be larger than the width. These pores will be accessible to a fluid or to a gas, i.e. pores having a continuous communication with the outside of the solid.

In the context of the present invention, the term “MOF” defines hybrid porous materials, also referred to by the term “metal-organic framework”, as compounds built from bridging organic ligands, also called “linkers” or “spacers”, which remain intact throughout the synthesis, these ligands acting as connectors in the network of the obtained MOF three-dimensional structure. As used herein, the term “ligand” or “linker” or “spacer” refers to a ligand coordinated with at least two metal sites, and also referred to as a “polydentate chelating ligand”, which contributes in creating the distance between these metal atoms and forming empty spaces or pores.

The “MOFs”, are solid adsorbents, which could be easily regenerated by known alternating pressure adsorption or adsorption at alternating temperature techniques. Examples of MOFs are described in the application EP3453450 (reference [1]).

By “three-dimensional structure”, it should be understood a three-dimensional sequence or repetition of units and/or patterns, or sub-variants, in the conventional meaning of the term in the field of MOFs materials, which are also characterised as “organometallic polymers”.

In the context of the present invention, the expression “average size of the pores”, which will also be referred to as “size of the pores”, refers to the size (or diameter of the pores) of the pores of the porous solid particles, for example MOF particles, as conventionally used in the art, calculated by the nitrogen adsorption method. It is intended to cover the different possible pore geometries of the MOF material (for example, tetrahedron, octahedron). Methods for measuring the size of the pores are well documented in the literature: cf. the reference [5]. For example, the size of the pores of the MOF may be determined by calculating the size distribution of the pores of the nitrogen adsorption. It is also possible to estimate the maximum and limit size of the pores from crystallographic data by simulating filling of the pores with gas molecules (reference [6]) which allow calculating the average sizes of the pores. In the context of the present invention, the specific surface area BET as well as the volume of the pores, have been determined by the N₂ adsorption method, on the basis of the N₂ adsorption-desorption isotherms at −196° C. (77K), and in particular with a TriStar® II device.

In the context of the present invention, the term “nanoparticle” refers to a particle whose size is smaller than 800 nm. In particular, the MOF adsorbent nanoparticles according to the invention may have a diameter (or size of the largest axis if the particles have an asymmetric shape) smaller than 800 nanometres, preferably smaller than 400 nm, more preferably smaller than 200 nm and possibly smaller than 100 nm.

In the context of the present invention, the term “microparticle” refers to a particle whose size is from 800 nm to several tens microns.

Preferably, the porous solid particles are taken in a content higher than or equal to 55% relative to the total mass of the obtained porous membrane, and advantageously the content is higher than 60%, more advantageously higher than 65%, and possibly higher than 70%.

The present invention also relates to a porous membrane susceptible to be obtained by the aforementioned preparation method of the description of the invention.

More particularly, the present invention relates to a porous material, and preferably a porous membrane, preferably obtained according to the method described before in the context of the present invention for capturing volatile organic compounds, referred to as VOCs, comprising:
50-85% of a porous solid particle;
15-50% of a cellulose matrix;
the percentages being percentages by mass of the mass of the ingredient considered relative to the total mass of the porous membrane; the porous solid particle being selected from at least one of the following particles: a zeolite particle, an activated charcoal particle, and a structured metal-organic compound particle, so-called MOF, which MOF includes polydentate chelating ligands.

Preferably, the porous solid particles content is from 55 to 80%, and advantageously said content is from 58 to 77%.

In the context of the present invention, the term “cellulose matrix” defines a matrix comprising at least two sources of cellulose, preferably nanocellulose and cellulose fibres, and more preferably cellulose microfibrils (MFC) combined with cellulose fibres. Advantageously, the porous solid particles cover the cellulose fibres, or are interposed between the cellulose fibres, and the nanocellulose is interposed between the porous solid particles so as to create preferred interactions with these particles. Such a structure of the matrix may be observed by scanning electron microscopy (SEM).

Preferably, the porous membrane according to the invention comprises a cellulose matrix containing from 0 to 30% of MFC and from 5 to 45% of cellulose fibres, the contents being expressed as a percentage by mass relative to the total mass of the porous membrane. Preferably, said MFC content is from 5 to 25%, and more preferably it is from 8 to 22%. Preferably, the cellulose fibres content is from 8 to 42%, and more preferably it is from 11.5 to 40.5%.

More preferably, the MFC content is higher than 15%, and even higher than 17%. Unexpectedly, the Inventors have been able to observe that an increase in the amount of MFC in the cellulosic fibre/MFC ratio results in an increase in the rigidity of the composite, as well as an increase in the retention of the particles within the composite.

Preferably, the cellulose fibres are cotton and resin fibres in a content higher than 15%, and even higher than 17%. Unexpectedly, the Inventors have been able to observe that a relatively higher cellulose fibre content, and in particular when it consist of the longest cellulose fibres, as is the case for softwood and cotton cellulosic fibre, allowed guaranteeing a flexibility of the material and avoiding it becoming brittle.

Preferably, the MOF particle comprises at least one metal selected from among Cu, Zn, Ca, Ln, Y, Mg, Ti, Zr, V, Cr, Mn, Fe and Al, preferably the metal is a Fe, Al or Zr metal ion, and advantageously it consists of a metal ion selected from among Fe metal ions.

Preferably, the polydentate chelating ligand is selected from among at least one type of ligand selected from among a bidentate ligand, a tridentate ligand and a tetradentate ligand, and advantageously comprises C₆-C₂₄ aromatic compounds including at least one function selected from among a carboxylic acid, phosphonic acid, amine, alcohol, ketone and azole function; preferably the polydentate chelating ligand is selected from among at least one of the ligands: benzene-1,3,5-tricarboxylic acid (C₆H₃(CO₂H)₃, CAS: 554-95-0), 3,3′,5,5′-azobenzenetetracarboxylic acid (C₁₆H₁₀N₂O₈, CAS: 365549-33-3), 3,5-pyrazoledicarboxylic acid (C₅H₄N₂O₄, CAS: 303180-11-2), 2,5-bistrifluoromethyl-1,4-benzenedicarboxylic acid (C₁₀H₄F₆O₄, CAS: 366008-67-5), 2-(trifluoromethyl)-1,4-benzenedicarboxylic acid (C₉H₅F₃O₄, CAS: 1483-47-2), 1,2,4-triazole (C₂H₃N₃, CAS: 288-88-0), 2-methylimidazole (C₄H₆N₂, CAS: 693-98-1), N,N′-piperazine(methylenephosphonic) acid (C₆H₁₆N₂O₆P₂, CAS: 89280-71-7), L-aspartic acid (C₄H₇NO₄, CAS: 56-84-8), 2,5-dihydroxydeterephthalic acid (C₈O₆H₆, CAS: 610-92-4) and 3,4-dihydroxy-3-cyclobutene-1,2-dione (C₄O₄H₂, CAS: 2892-51-5).

Preferably, the porous solid particle comprises nanoparticles and/or microparticles with a diameter of 50 nm to 80 μm. Good mechanical properties (very satisfactory mechanical strength, easy to handle and highly flexible) have been noticed for the membranes formulated from MIL-100(Fe) nanoparticles (size smaller than 100 nm) as well as MOFs with a size of about 200 nm (Al-PDA, MIL-53-CF₃). MOFs, whose particle sizes are 800 nm (MIL-127(Fe) and UiO-66-2CF₃(Zr)) up to 3 μm (MIL-100(Fe)) as well as polydispersed microparticles of activated charcoal with a size of 5 to 80 μm and NaY zeolite particles with a size of 700 nm, also offer ideal mechanical properties. The size of the particles is determined by a method consisting in observing the particles by scanning electron microscopy (SEM) and measuring the size of the particles (a sampling of 60 and 70 particles) using the ImageJ™ software.

Preferably, the MOF is selected from among MIL-100(Fe), MIL-127(Fe), Ca-squarate (amphiphilic), Al-PDA (also so-called MOF-303; hydrophilic nature), MIP-202(Zr) (hydrophilic), MIL-91(Ti) (hydrophilic) or from among one of the hydrophobic MOFs: UiO-66(Zr)-2CF₃, MIL-53(Al)-CF₃, CALF-20, ZIF-8.

Advantageously, the thickness of the membrane is 150-500 μm. When it is in the form of a monolith, the thickness may advantageously reach 1, or several millimetres. The thickness of the membrane being measured using a Vintage™ mechanical micrometer commercialised under the reference MK 0-25 mm, with an accuracy of 0.01 mm (K, USSR).

The present invention also relates to the use of a porous membrane as described before in the context of the present invention; in order to perform the separation of gases and vapours; perform an adsorption; perform a catalysis, advantageously for an environment and/or energy application.

Preferably, the use of the porous membrane according to the invention is implemented in order to purify the ambient air or to purify a storage space containing objects sensitive to VOCs. An example of the sensitive objects that should be preserved is described in the reference [7].

Preferably, the porous membrane is used to capture CO₂ of ambient air or in an industrial environment, separate gases, store gases (hydrogen, methane) or for proton conductivity in sustainable energy systems. Examples of such applications are described in the reference [8] to [12].

Preferably, the use of the porous membrane is implemented to treat air by adsorption of water for dehumidification, fresh water production, air-conditioning or heating, inter-seasonal heat storage, decontamination in the ambient air of the exhaust gases of an engine comprising NOx. Examples of such applications are described in the references [13] to [15].

The present invention is also described in the following detailed description, using the experimental part which details some embodiments using examples, given only for illustration and which should not be considered as restrictive, and the figures briefly described in the following part.

### BRIEF DESCRIPTION OF THE FIGURES

FIG. 1 shows the X-ray diffractograms of the MIL-100(Fe) microparticles of Example 1 and in the form of a paper membrane of Example 16;

FIG. 2 shows the thermogravimetric analysis (in air, heating rate of 5° C./minute) of the MIL-100(Fe) microparticles of Example 1 and in the form of a paper membrane of Example 16;

FIG. 3 shows the dinitrogen adsorption-desorption isotherms at 77K obtained after activation of the MIL-100(Fe) microparticles of Example 1 and in the form of a paper membrane of Example 16;

FIGS. 4a and 4b show the images of the paper membrane containing 75% w/w of MIL-100(Fe) microparticles of Example 16, obtained by scanning electron microscopy at different magnifications: (a) ×10,000 and (b) ×15,000; and FIGS. 4c and 4d show the histograms illustrating the size distribution of the MIL-100(Fe) particle obtained of Example 1 and the size distribution of the microfibrillated cellulose fibres;

FIG. 5 shows the X-ray diffractograms of the MIL-100(Fe) nanoparticles of Example 2;

FIG. 6 shows the thermogravimetric analysis (in air, heating rate of 5° C./minute) of the MIL-100(Fe) nanoparticles of Example 2;

FIG. 7 shows the dinitrogen adsorption-desorption isotherm at 77K obtained after activation of the MIL-100(Fe) nanoparticles of Example 2;

FIG. 8 shows the X-ray diffractograms of the MIL-127(Fe) microparticles as such of Example 3; and in the form of a paper membrane of Example 17;

FIG. 9 shows the thermogravimetric analysis (in air, heating rate of 5° C./minute) of the MIL-127(Fe) microparticles of Example 3 and in the form of a paper membrane of Example 18;

FIG. 10 shows the dinitrogen adsorption-desorption isotherms at 77K obtained after activation of the MIL-127(Fe) microparticles of Example 3 and in the form of a paper membrane of Example 17;

FIG. 11 shows the X-ray diffractograms of the Al-PDA nanoparticles as such of Example 4 and in the form of a paper membrane of Example 18;

FIG. 12 shows the thermogravimetric analysis (in air, at a heating rate of 5° C./minute) of the Al-PDA nanoparticles as such of Example 4 and in the form of a paper membrane of Example 18;

FIG. 13 shows the dinitrogen adsorption-desorption isotherms at 77K obtained after activation of the Al-PDA nanoparticles as such in Example 4 and in the form of a paper membrane of Example 18;

FIGS. 14a, 14b and 14c show the images of the paper membrane containing 75% by mass, relative to the total mass of the membrane, of Al-PDA nanoparticles of Example 18 and FIG. 14d shows the histogram illustrating the size distribution of the Al-PDA particles obtained of Example 4;

FIG. 15 shows the X-ray diffractograms of the UiO-66(Zr)-2CF₃ microparticles as such of Example 5 and in the form of a paper membrane of Example 19;

FIG. 16 shows the thermogravimetric analysis (in air, heating rate of 5° C./minute) of the UiO-66(Zr)-2CF₃ microparticles; as such of Example 5 and in the form of a paper membrane of Example 19;

FIG. 17 shows the dinitrogen adsorption-desorption isotherm at 77K obtained after activation of the UiO-66(Zr)-2CF₃ microparticles as such of Example 5 and in the form of a paper membrane of Example 17;

FIG. 18 shows the X-ray diffractograms of the MIL-53(Al)-CF₃ nanoparticles of Example 6;

FIG. 19 shows the thermogravimetric analysis (in air, heating rate of 5° C./minute) of the MIL-53(Al)-CF₃ nanoparticles as such of Example 6 and in the form of a paper membrane of Example 20;

FIG. 20 shows the dinitrogen adsorption-desorption isotherms at 77K obtained after activation of the MIL-53(Al)-CF₃ nanoparticles as such of Example 6 and in the form of a paper membrane of Example 20;

FIG. 21 shows the X-ray diffractograms of zeolite NaY as such of Example 7 and in the form of a paper membrane of Example 22;

FIG. 22 shows the thermogravimetric analysis (in air, heating rate of 5° C./minute) of the NaY zeolite microparticles as such of Example 7 and in the form of a paper membrane of Example 22;

FIG. 23 shows the dinitrogen adsorption-desorption isotherms at 77K obtained after activation of the NaY microparticles as such of Example 7 in the form of a paper membrane of Example 22;

FIG. 24 shows the experimental X-ray diffractograms of the activated charcoal microparticles as such of Example 8 and in the form of a paper membrane of Example 21;

FIG. 25 shows the thermogravimetric analysis (in air, heating rate of 5° C./minute) of the activated charcoal microparticles as such of Example 8 and in the form of a paper membrane of Example 21;

FIG. 26 shows the dinitrogen adsorption-desorption isotherms at 77K obtained after activation of the activated charcoal microparticles of Example 8 and in the form of a paper membrane of Example 21;

FIG. 27a shows the image of the activated charcoal powder of Example 8, FIG. 27b shows the histogram illustrating the size distribution of the activated charcoal particles described in Example 8 and FIG. 27c shows the image of the paper membrane containing 75% by mass, relative to the total mass of the membrane, of the activated charcoal microparticles of Example 21;

FIG. 28 shows the X-ray diffractograms of the paper membranes formulated with the different MIL-100(Fe) nanoparticles of Example 9;

FIG. 29 shows the thermogravimetric analyses (in air, heating rate of 5° C./minute) of the different paper membranes formulated with the MIL-100(Fe) nanoparticles of Example 9;

FIG. 30 shows the dinitrogen adsorption-desorption isotherms at 77K obtained after activation of the different paper membranes formulated with the MIL-100(Fe) nanoparticles of Example 9;

FIG. 31 shows the X-ray diffractograms of the different paper membranes formulated with the microparticles of MIL-100(Fe) and of MIL-127(Fe) of Examples 10 and 11;

FIG. 32 shows the thermogravimetric analysis (in air, heating rate of 5° C./minute) of the different paper membranes formulated with the MIL-100(Fe) microparticles of Example 10;

FIG. 33 shows the dinitrogen adsorption-desorption isotherms at 77K obtained after activation of the different paper membranes formulated with the microparticles of MIL-100(Fe) and of MIL-127(Fe) of examples 10 and 11;

FIG. 34 shows the thermogravimetric analysis (in air, heating rate of 5° C./minute) of the different paper membranes of Example 11;

FIG. 35 shows the stress-strain curves obtained by tensile testing of the different paper membranes of Example 12;

FIG. 36 shows the stress-strain curves obtained by tensile testing of the different paper membranes of Example 13;

FIG. 37 shows the stress-strain curves obtained by tensile testing of the different paper membranes of Example 14;

FIG. 38 shows the stress-strain curves obtained by tensile testing of the different paper membranes of Example 15;

FIG. 39 shows the force vs. bending angle curves obtained by two point bending tests of the different membranes of Example 16;

FIG. 40 shows the evolution of the degree of polymerisation of the cellulose after different ageing times of the microparticles with or without a paper membrane of Example 17;

FIG. 41 shows the X-ray diffractograms of the MIL-160(Al) particles of Example 25;

FIG. 42 shows the carbon dioxide (CO₂) adsorption isotherm at 298K obtained after activation of the MIL-160(Al) monolith of Example 26;

FIG. 43 shows the X-ray diffractograms of the MIL-53(Al) solid of Example 27;

FIG. 44 shows the carbon dioxide (CO₂) adsorption isotherm at 298K obtained after activation of the MIL-53(Al) monolith of Example 28;

FIG. 45 shows a setup intended for the measurement of VOCs;

FIG. 46 SEM (scanning electron microscope) image of paper membranes with the MIL-100(Fe) microparticles of Example 18;

FIG. 47-FIG. 48 SEM image of paper membranes with the activated charcoal microparticles of Example 23; and

FIG. 49-FIG. 50 SEM image of paper membranes with the zeolite microparticles of Example 24.

### EXPERIMENTAL PART

### Analysis and Experimental Protocols

The analysis of the crystalline structure of the porous solids has been performed by X-ray powder diffraction (XRD) using a D8 Bruker® Advance diffractometer equipped with a copper source (CuKα radiation λ_{Cu}=1.5406 Å), at room temperature, in air. The obtained diffractograms are represented in angular distances (2 theta, in degrees).

The characterisation of the average size of the pores of the solids has been performed by dinitrogen N₂ adsorption porosimetry at 77K with a TriStar® II apparatus. The samples have been activated under primary vacuum using a Micromeritics® degasser overnight at temperatures comprised between 15° and 200° C. The dinitrogen adsorption isotherm of the solids represents the adsorbed amount of gas (in cm³·g¹) according to the relative pressure P/P₀.

The thermogravimetric analysis has been performed in air using a Model Mettler Toledo™ TGA/DSC2, STAR system apparatus. The samples (about 10 mg each) have been heated at a rate of 5° C./minute. The resulting thermogram represents the loss of mass Pm (in %) as a function of the temperature T (in ° C.).

The observation of the surface topography of the samples has been performed by scanning electron microscopy using an ESEM Quattro™ (commercialised by ThermoFischer Scientific™).

The length of the cellulose microfibrils (or microfibrillated cellulose) has been verified by optical microscopy (Zeiss® AX10, ×100 magnification) while taking care to have an aqueous interface between the glass plate and the lamella to avoid aggregation of the fibres. The used cellulose microfibrils are commercialised by Weidmann® and have a median length D50 comprised between 8 and 10 μm measured according to the standard ISO 13322-2:2006-11.

The distribution of the sizes of the nanoparticles and of the microparticles is that one given and measured according to the method described in the reference and [2]; the nano and microparticles have been observed with SEM and the size measurements of the particles are performed with the ImageJ™ software.

In the context of the invention, a mass percentage expressed in % w/w, defines the mass percentage of an ingredient used in the preparation and considered with respect to the total mass of the considered object: a mixture, a material (composite, etc.), a membrane, etc.

### EXAMPLES

Part 1: Synthesis and Results—Porous Solids Used within the Paper Membranes

This part describes the synthesis of various metal carboxylates of interest for the implementation of the present invention.

MIL-100(Fe) or Fe₃O[C₆H₃—(CO₂)₃]₂·OH·nH₂O

The iron carboxylate MIL-100(Fe) has been synthesised with two grain size distributions of different particles: nanoparticles with a size smaller than 100 nm (average size: 84 nm+/−13 according to the ref. [16]) and microparticles of 1 to 3 microns. The size distribution of the microparticles calculated from 5 SEM images of the paper membranes containing 75% w/w of MIL-100(Fe) microparticles. Size determined with the Image j software on about 70 particles (average size: 1.4 μm+/−0.4).

### Example 1: Synthesis of the MIL-100(Fe) Microparticles

3.68 g of metal iron in powder (66 mmol, commercialised by the Riedel de Haën® company, 99%) and 9.24 g of 1,3,5-benzenetricarboxylic acid or trimesic acid (44 mmol, 1,3,5-BTC commercialised by the Alfa Aesar® company, 99%) are added to a 500 mL round-bottomed flask and then 366 mL of distilled water. The round-bottomed flask is stirred at 500 rpm at room temperature. Nitric acid (65%, commercialised by the Carlo Ferba Reagents™ company) is added (V=2.7 mL). The round-bottomed flask is left under stirring for 1 week under stirring. The solid is recovered by filtration and then reinserted into the reaction round-bottomed flask with addition of 400 mL of distilled water under stirring (500 rpm) for 1 h30 in order to remove the acid trimesic in the pores. The solid is filtered and resuspended in 400 mL of absolute ethanol (commercialised by Carlo Ferba Reagents™) for a last wash for 30 minutes at 40° C. in order to remove the remaining nitrate counterions (NO₃⁻) and traces of trimesic acid. The solid is recovered by hot filtration. Finally, the latter is dried at room temperature.

### Results

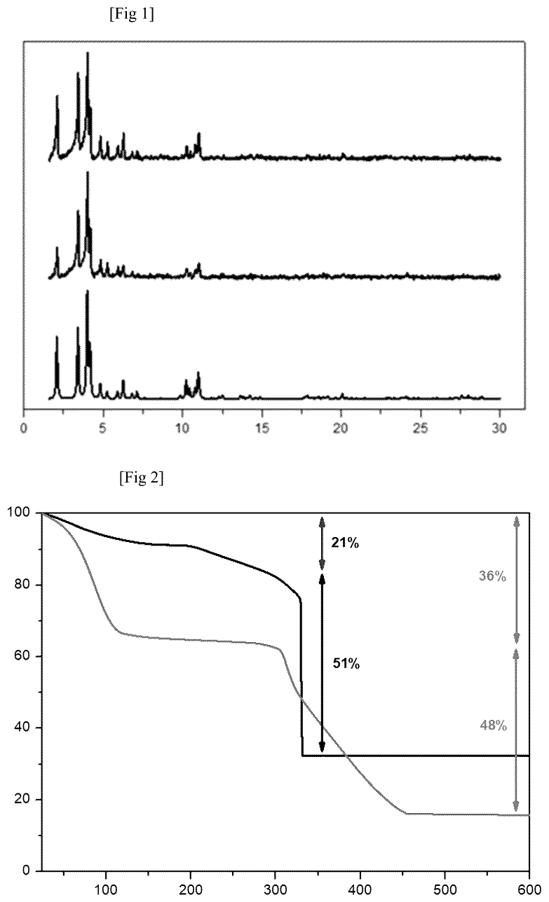

The results are summarised in FIGS. 1-3:

FIG. 1 shows the X-ray diffractograms of the simulated MIL-100(Fe) solid (curve (a) at the bottom), experimental in powder (curve (b) at the middle) and in the form of a paper membrane (curve (c) at the top) (microparticles grain size distribution) (λ_{Cu}≈1.5406 Å)), on the ordinate axis: arbitrary relative intensity (a.u.), on the abscissa axis: 2-theta (deg.);

FIG. 2 shows the thermogravimetric analysis (in air, heating rate of 5° C./minute) of the MIL-100(Fe) microparticles after washing and drying in the powder state ((a) in black) and in the form of a paper membrane ((b) in grey), the loss of mass Pm (in %) is represented as a function of the temperature T (in ° C., on the abscissa axis): on the ordinate axis=the remaining mass (in %);

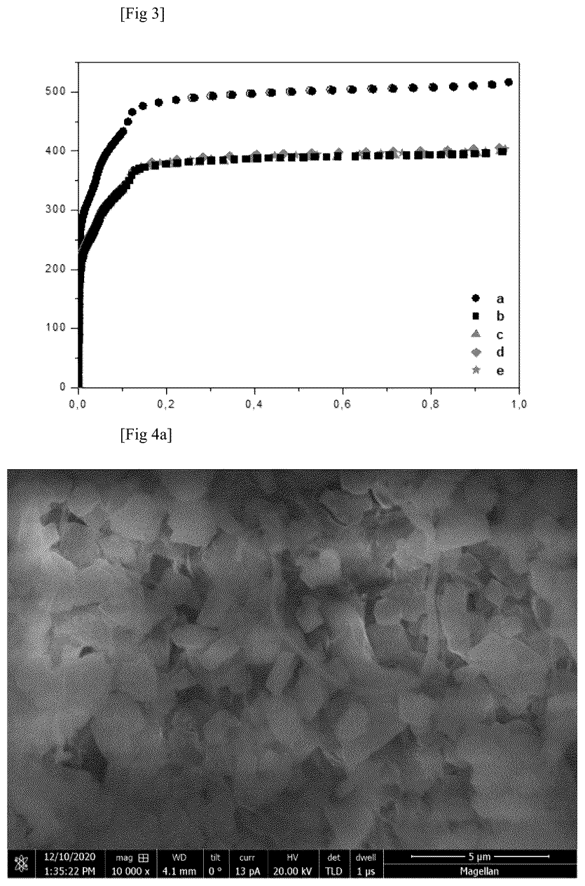

FIG. 3 shows the dinitrogen adsorption-desorption isotherms at 77K obtained after activation of the MIL-100(Fe) solid in powder (microparticles grain size distribution) (isotherm a, points of the curve represented by black circles) and in the form of a paper membrane (isotherm b, points of the curve represented by black squares) as well as paper membranes regenerated after adsorption of acetic acid (isotherm c, points of the curve represented by grey triangles), acrylic acid (called d, points of the curve represented by grey squares) and furfural (denoted e, points of the curve represented by grey lozenges) (P₀=1 atm.) at 150° C. overnight, on the ordinate axis: N₂ volume (cm³·g⁻¹), on the abscissa axis: Relative Pressure (the black circles correspond to the adsorption, the white circles to the desorption; (microparticles grain size distribution) (P₀=1 atm.)). The obtained specific surface area BET of the MTL-100(Fe) powder is 1,835 m²·g⁻¹+/−4.4 and a pore volume of 0.795 cm³·g⁻¹.

### Example 2: Synthesis of the MIL-100(Fe) Nanoparticles

The synthesis conditions are given in the reference [16]. 281.2 mg of trimesic acid (1.34 mmol, commercialised by Alfa Aesar®, 98%) have been dispersed in 100 mL of distilled water under stirring (300 rpm) and then addition of 810 mg of Fe(NO₃)₃·9H₂O (3.35 mmol, commercialised by the Sigma-Aldrich®, 98%). The whole is left under stirring for 48 hours. Either the solution is kept as it is in order to avoid the irreversible aggregation of the nanoparticles and the washings are done after formation of the paper membrane, or the solid is washed with a volume of 100 mL of distilled water and then 100 mL of absolute ethanol at 40° C. (commercialised by Carlo Ferba Reagents™). And the solid is dried under vacuum at room temperature under vacuum.

### Results

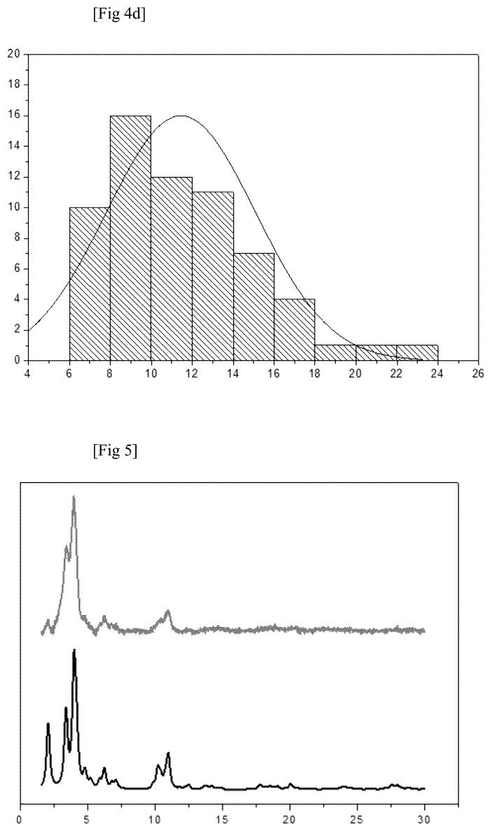

The results are summarised in FIGS. 5-7:

FIG. 5 shows the X-ray diffractograms of the simulated MIL-100(Fe) solid (curve (a) at the bottom) and experimental (curve (b) at the top, (nanoparticles grain size distribution) (λ_{Cu}≈1.5406 Å)), on the ordinate axis: arbitrary relative intensity (a.u.), on the abscissa axis: 2-theta (deg.);

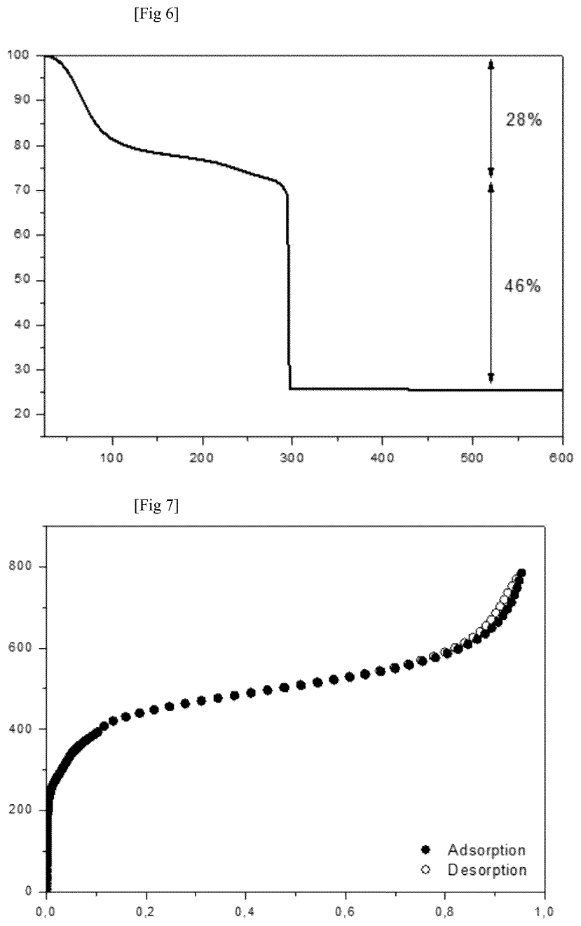

FIG. 6 shows the thermogravimetric analysis (in air, heating rate of 5° C./minute) of the MIL-100(Fe) nanoparticles after washing and drying. The loss of mass Pm (in %) is represented as a function of the temperature T (in ° C., on the abscissa axis): on the ordinate axis=the remaining mass (in %);

FIG. 7 shows the dinitrogen adsorption-desorption isotherm at 77K obtained after activation of the MIL-100(Fe) nanoparticles at 150° C. overnight, on the ordinate axis: N₂ volume (cm³·g⁻¹), on the abscissa axis: Relative Pressure (the black circles correspond to the adsorption, the white circles to the desorption; (nanoparticles grain size distribution) (P₀=1 atm.)). The obtained specific surface area BET of the MIL-100(Fe) powder and 1,668 m²·g¹+/−4 is a pore volume of 1.2 cm³·g¹.

MIL-127(Fe) or Fe₃O[C₁₂N₂H₆(CO₂)₄]_{3/2}·3H₂O

### Example 3: Synthesis of the MIL-127(Fe) Particles

The synthesis protocol has been derived from a protocol reported in the literature [4]. First of all, a sodium hydroxide solution has been prepared upstream by mixing under stirring 6.4 g of sodium hydroxide (160 mmol, NaOH commercialised by Alfa Aesar®) in 40 mL of distilled water until complete dissolution. Concomitantly, a solution containing 27.13 g of hexahydrated iron chloride (100 mmol, FeCl₃·6H₂O commercialised by Alfa Aesar®) and 80 mL of 2-propanol (IPA, commercialised by Carlo Ferba Reagents™) has been stirred (300 rpm) at 50° C. until complete dissolution of the ferric salt. In a second step, 16.16 g of 3,3′,5,5′-azobenzenetetracarboxylic acid ligand (H₄TazBz, synthesis of ligand described in Part 2) have been ground in a mortar and then dispersed in 100 mL of IPA in a 500 mL round-bottomed flask under stirring at 50° C. until obtaining a homogeneous solution. Upon completion of this step, the sodium hydroxide solution is added to the round-bottomed flask and then, consecutively, the ferric salt solution. The round-bottomed flask is placed under reflux (120° C.) and under stirring (700 rpm) for 24 h. The yellow solid is filtered and then washed twice with absolute ethanol (commercialised by Carlo Ferba Reagents™) at room temperature for 1 h. Finally, a last wash is carried out with boiling water for 30 minutes in order to remove part of the solvents (IPA and ethanol) inside the pores. Afterwards, the solid is dried under vacuum at room temperature.

### Results

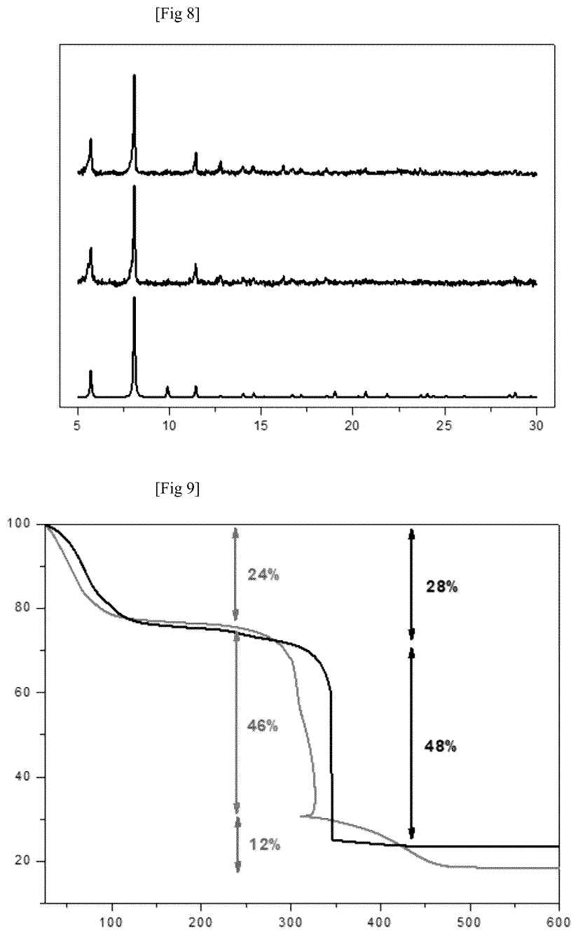

The results are summarised in FIGS. 8-10:

FIG. 8 shows the X-ray diffractograms of the simulated MIL-127(Fe) solid (curve (a) at the bottom), experimental in powder (curve (b) at the middle) and in the form of a paper membrane (curve (c) at the top) (microparticles grain size distribution) (λ_{Cu}≈1.5406 Å)), on the ordinate axis: arbitrary relative intensity (a.u.), on the abscissa axis: 2-theta (deg.);

FIG. 9 shows the thermogravimetric analysis (in air, heating rate of 5° C./minute) of the MIL-127(Fe) microparticles after washing and drying in the powder state ((a) in black) and in the form of a paper membrane ((b) in grey). The loss of mass Pm (in %) is represented as a function of the temperature T (in ° C., on the abscissa axis): on the ordinate axis=the remaining mass (in %);

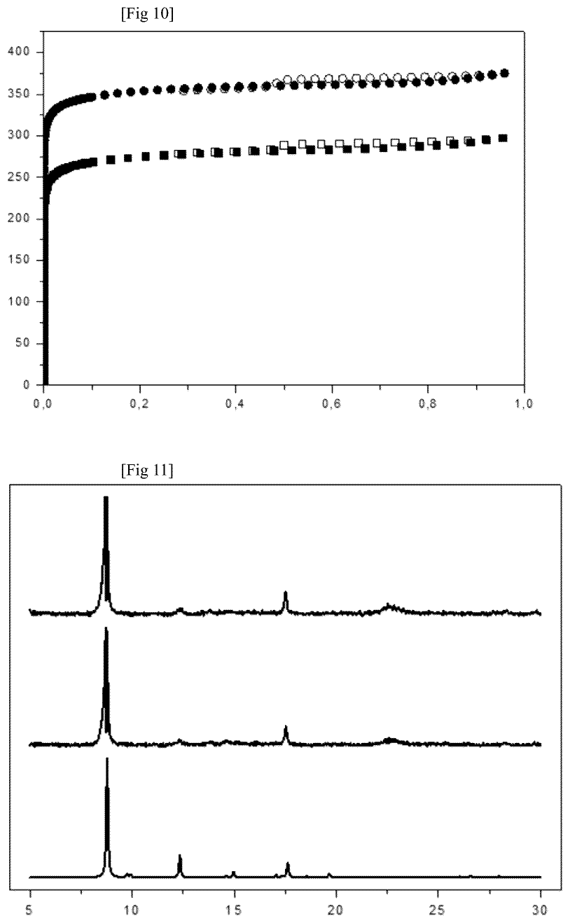

FIG. 10 shows the dinitrogen adsorption-desorption isotherms at 77K obtained after activation of the MIL-127(Fe) microparticles in powder (points of the curve represented by circles) and in the form of a paper membrane (points of the curve represented by squares) at 150° C. overnight, on the ordinate axis: N₂ volume (cm³·g⁻¹), on the abscissa axis: Relative Pressure (the black circles correspond to the adsorption, the white circles to the desorption; (microparticles grain size distribution) (P₀=1 atm.)). The obtained specific surface area BET of the MIL-127(Fe) powder and 1,427 m²·g⁻¹+/−0.63 is a pore volume of 0.579 cm³·g⁻¹.

Al-PDA or Al(OH)(C₅H₂N₂O₄)(H₂O)

The size distribution of the nanoparticles calculated from 5 SEM images of the paper membranes containing 75% w/w of Al-PDA. Size determined with the ImageJ™ software on about 70 particles (average size: 234.9 nm+/−60).

### Example 4: Synthesis of the Al-PDA Particles

The synthesis conditions are given in the reference [17]. 1.045 g of monohydrated 3,5-pyrazolecarboxylic acid (6 mmol, 3,5-PDA commercialised by Alfa Aesar®, 98%) and 0.468 g of monohydrated aluminium hydroxide (6 mmol, Al(OH)₃·H₂O commercialised by Sigma®) have been added to 60 ml of distilled water under stirring (300 rpm) and then the solution has been refluxed (100° C.) for 18 h. The white solid is recovered by filtration and then redispersed in 60 mL of distilled water and washed for 5 h at 100° C. Finally, after filtration, the latter is dried at 100° C. for 2 h.

### Results

The results are summarised in FIGS. 11-14 c:

FIG. 11 shows the X-ray diffractograms of the simulated Al-PDA solid (curve (a) at the bottom), experimental in powder (curve (b) at the middle), (nanoparticles grain size distribution) (λ_{Cu}≈1.5406 Å)), on the ordinate axis: arbitrary relative intensity (a.u.)), on the abscissa axis: 2-theta (deg.);

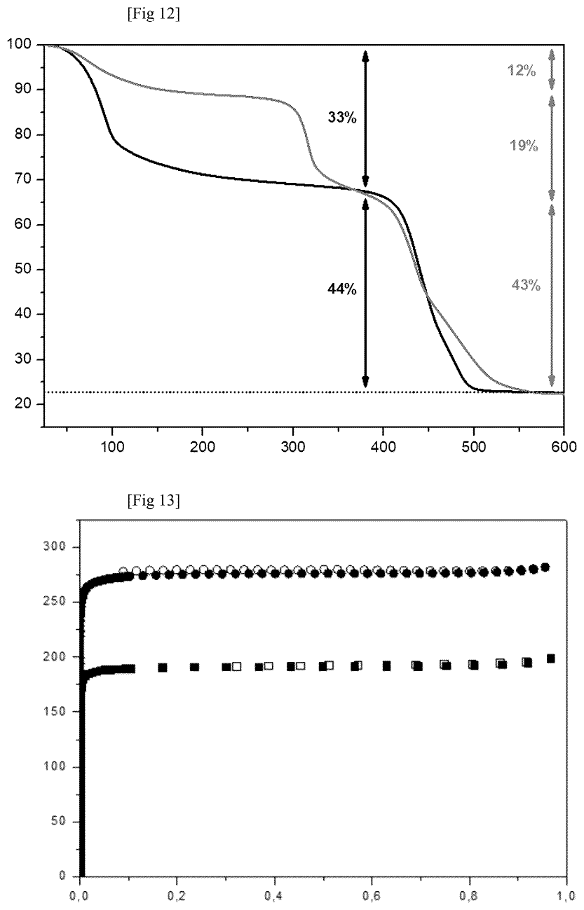

FIG. 12 shows the thermogravimetric analysis (in air, at a heating rate of 5° C./minute) of the Al-PDA nanoparticles after washing and drying in the powder state ((a) in black). The loss of mass Pm (in %) is represented as a function of the temperature T (in ° C., on the abscissa axis): on the ordinate axis=the remaining mass (in %);

FIG. 13 shows the dinitrogen adsorption-desorption isotherms at 77K obtained after activation of the Al-PDA nanoparticles in powder (points of the curve represented by circles) at 200° C. for 5 h, on the ordinate axis: N₂ volume (cm³·g⁻¹), on the abscissa axis: Relative Pressure (the black circles correspond to the adsorption, the white circles to the desorption; (nanoparticles grain size distribution) (P₀=1 atm.)). The obtained specific surface area BET of the Al-PDA powder is 1,152 m²·g⁻¹+/−1.2 and a pore volume of 0.527 cm³·g⁻¹.

UiO-66(Zr)-2CF₃ or Zr₆O₄(OH)₄(C₆H₂2CF₃C₂O₄)₆

### Example 5: Synthesis of the UiO-66(Zr)-2CF₃ Particles

This synthesis has been adapted from a non-functionalised UiO-66 synthesis reported in the literature [18]. 536 mg of zirconium (IV) chloride (2.3 mmol, Zr(Cl)₄ commercialised by Acros Organics®, 98%) and 11.2 g of benzoic acid have been (91.7 mmol, C₆H₅COOH commercialised by Alfa Aesar®, 99%) have been inserted into a laboratory bottle of 1 L and then 264 mL of N,N-dimethylformamide have been added (DMF commercialised by Carlo Ferba Reagents™). This bottle is placed a few minutes in an ultrasonic bath and then after complete dissolution of the reagents, 695 mg of 2,5-bistrifluoromethyl-1,4-benzenedicarboxylic acid (2.3 mmol of H₂BDC-2CF₃ commercialised by Angene™). The mixture is stirred (300 rpm) for a few minutes until obtaining a homogeneous solution (a few minutes). The bottle is closed using a cap and placed in the oven at 120° C. for 48 h. The white solid is isolated by centrifugation (10,000 rpm for 10 minutes), washed with 150 mL of acetone and then centrifuged and dispersed in 100 mL of absolute ethanol (commercialised by Carlo Ferba Reagents™). The solution is stirred for 24 h at 70° C. in order to remove all traces of unreacted ligand and of modulator (benzoic acid) present in the reaction medium.

### Results for the Zirconium Carboxylate Solid UiO-66(Zr)-2CF₃

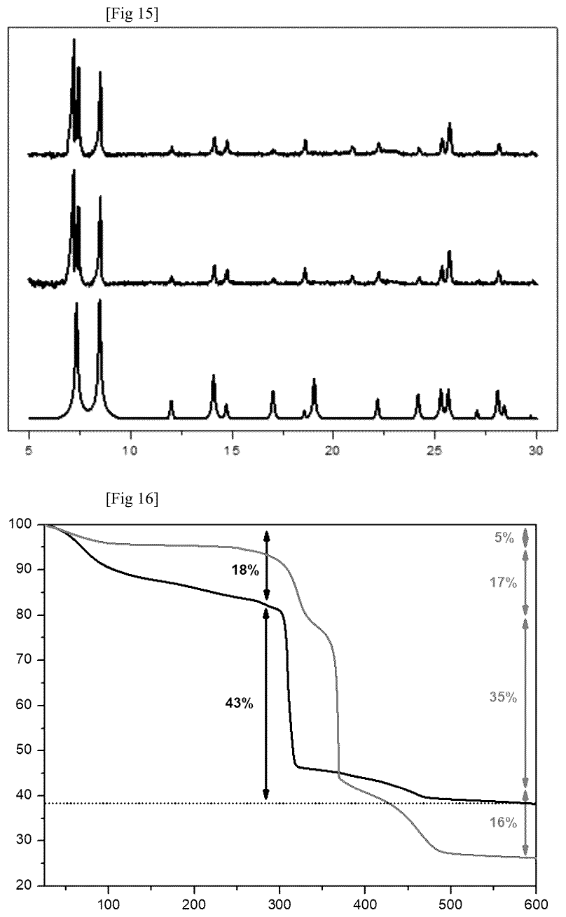

The results are summarised in FIGS. 15-17:

FIG. 15 shows the X-ray diffractograms of the simulated UiO-66(Zr)-2CF₃ solid (curve (a) at the bottom), experimental in powder (curve (b) at the middle) (microparticles grain size distribution) (λ_{Cu}≈1.5406 Å)), on the ordinate axis: arbitrary relative intensity (a.u.), on the abscissa axis: 2-theta (deg.);

FIG. 16 shows the thermogravimetric analysis (in air, heating rate of 5° C./minute) of the UiO-66(Zr)-2CF₃ microparticles after washing and drying in the powder state ((a) in black). The loss of mass Pm (in %) is represented as a function of the temperature T (in ° C., on the abscissa axis): on the ordinate axis=the remaining mass (in %);

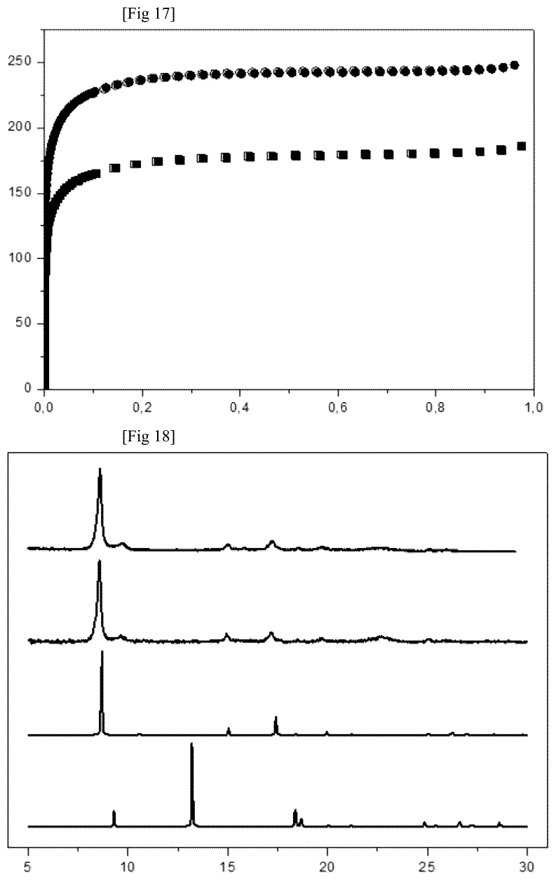

FIG. 17 shows the dinitrogen adsorption-desorption isotherm at 77K obtained after activation of the UiO-66(Zr)-2CF₃ microparticles in the powder state at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)). The obtained specific surface area BET of the UiO-66-2CF₃(Zr) powder is 977 m²·g⁻¹+/−0.4 and a pore volume of 0.41 cm³·g⁻¹.

MIL-53(Al)-CF₃ or Al(OH)(C₆H₃CF₃C₂O₄)

### Example 6: Synthesis of the MIL-53-CF₃ Particles

The synthesis protocol of this solid is derived from the reference, [19]. 11.584 g of hexahydrated aluminium chloride (48 mmol, Al(Cl)₃.6H₂O commercialised by Alfa Aesar®, 98%), 7.5 g of 2-(trifluoromethyl)-1,4-benzenedicarboxylic acid (32 mmol, 2-BDC-CF₃ commercialised by Angene™) and 2.56 g of sodium hydroxide (64 mmol, NaOH commercialised by Alfa Aesar, 98%) have been dispersed in 400 mL of water and the mixture has been placed under reflux for 16 h. The solid has been isolated by centrifugation (10 minutes, 12,000 rpm) and the latter has been dispersed in 400 mL of absolute ethanol (commercialised by Carlo Ferba Reagents) for washing overnight at 70° C. The white solid has been isolated again by centrifugation (same conditions) and then dried at 90° C. for 3 h in an oven.

### Results

These results are summarised in FIGS. 18-20:

FIG. 18 shows the X-ray diffractograms of the simulated MIL-53(Al)-CF₃ solid (two curves for two different pore sizes (a) at the bottom), experimental in the powder state (curve (b) at the top, (nanoparticles grain size distribution) (λ_{Cu}≈1.5406 Å)), on the ordinate axis: arbitrary relative intensity (a.u.), on the abscissa axis: 2-theta (deg.);

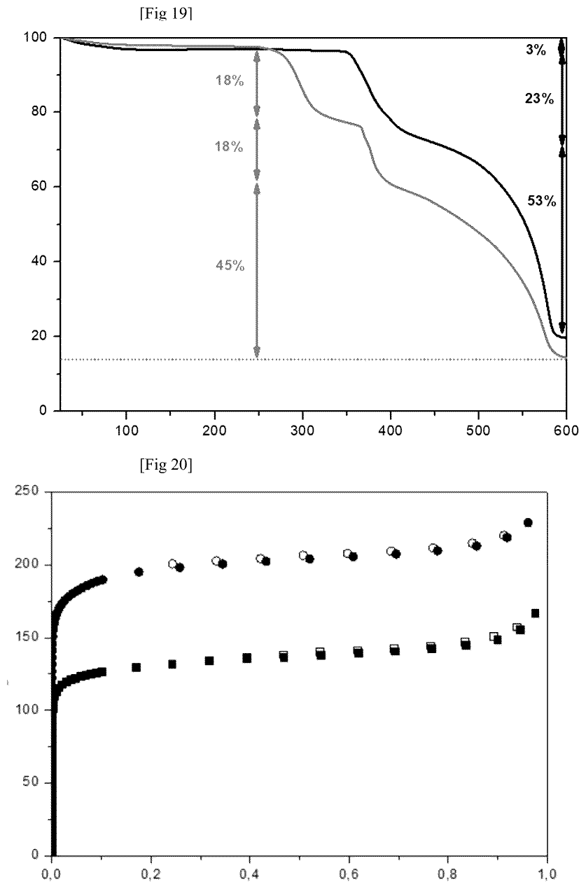

FIG. 19 shows the thermogravimetric analysis (in air, heating rate of 5° C./minute) of the MIL-53(Al)-CF₃ nanoparticles after washing and drying in the powder state ((a) in black). The loss of mass Pm (in %) is represented as a function of the temperature T (in ° C., on the abscissa axis): on the ordinate axis=the remaining mass (in %);

FIG. 20 shows the dinitrogen adsorption-desorption isotherms at 77K obtained after activation of the MIL-53(Al)-CF₃ nanoparticles in powder (points of the curve represented by circles) at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)). The obtained specific surface area BET of the MIL-53-CF₃ powder is 763.7 m²·g¹+/−0.6 and a pore volume of 0.351 cm³·g⁻¹.

NaY Zeolite or Na₂O·Al₂O₃·5.1SiO₂

### Example 7: The Zeolite is a Commercial Product and has been Ordered from Alfa Aesar® (CAS: 1318-02-1)

### Results

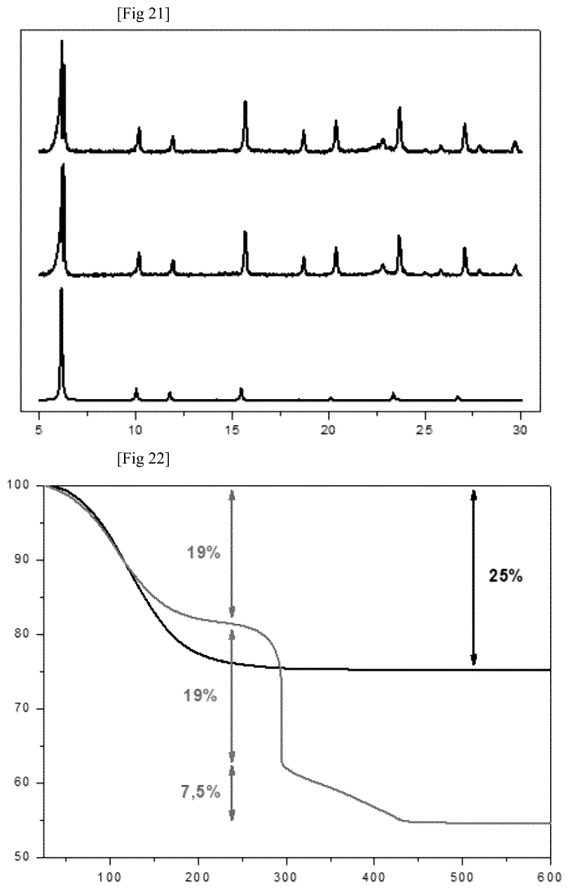

The results are summarised in FIGS. 21-23:

FIG. 21 shows the X-ray diffractograms of the simulated NaY zeolite (curve (a) at the bottom), experimental in the powder state (curve (b) at the middle), (microparticles grain size distribution) (λ_{Cu}≈1.5406 Å)), on the ordinate axis: arbitrary relative intensity (a.u.), on the abscissa axis: 2-theta (deg.);

FIG. 22 shows the thermogravimetric analysis (in air, heating rate of 5° C./minute) of the NaY zeolite microparticles after washing and drying in the powder state ((a) in black). The loss of mass Pm (in %) is represented as a function of the temperature T (in ° C., on the abscissa axis): on the ordinate axis=the remaining mass (in %);

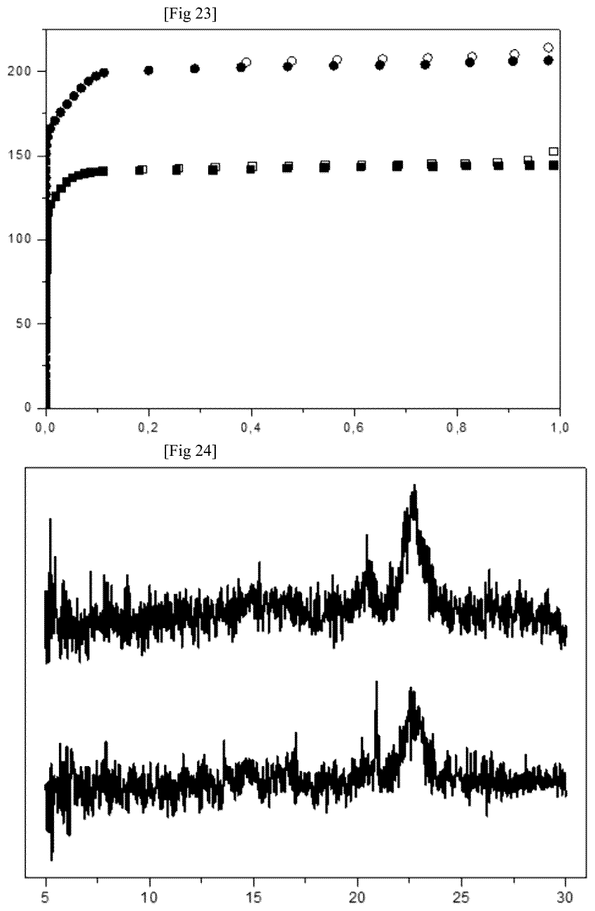

FIG. 23 shows the dinitrogen adsorption-desorption isotherms at 77K obtained after activation of the NaY zeolite microparticles in powder (points of the curve represented by circles) at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)). The obtained specific surface area BET of the NaY zeolite powder is 845 m²·g⁻¹+/−0.5 and a pore volume of 0.327 cm³·g¹.

### Activated Charcoal

The size distribution of the microparticles calculated from 5 SEM images of activated charcoal powder. Size determined with the ImageJ™ software on about 70 particles (average size: 23.5 μm+/−16.9).

### Example 8: The Activated Charcoal is a Commercial Product and has been Ordered from Fischer Scientific™ (CAS: 7440-44-0)

### Results

The results are summarised in FIGS. 24-27:

FIG. 24 shows the experimental X-ray diffractograms of the activated charcoal microparticles in powder (curve (a) at the bottom), (microparticles grain size distribution) (λ_{Cu}≈1.5406 Å)), on the ordinate axis: arbitrary relative intensity (a.u.), on the abscissa axis: 2-theta (deg.);

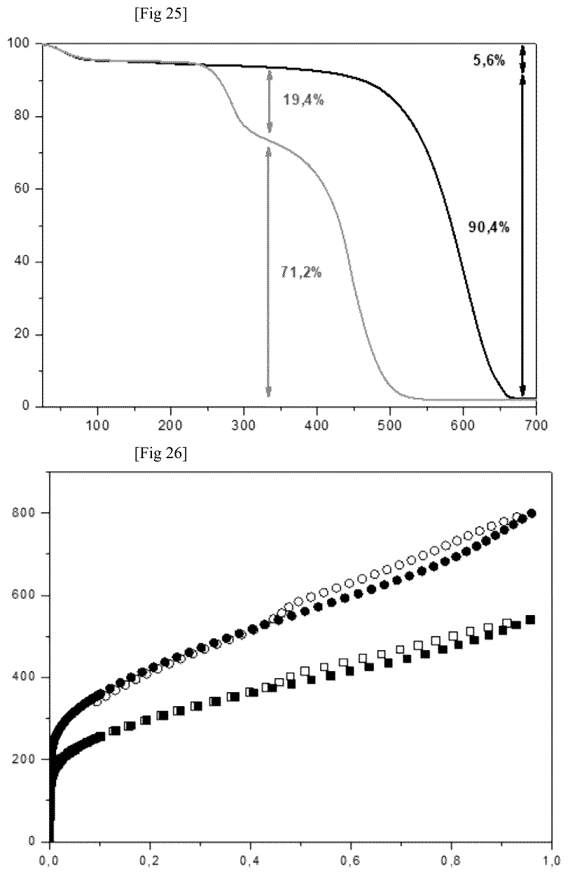

FIG. 25 shows the thermogravimetric analysis (in air, heating rate of 5° C./minute) of the activated charcoal microparticles of Example 8 after washing and drying in the powder state ((a) in black). The loss of mass Pm (in %) is represented as a function of the temperature T (in ° C., on the abscissa axis): on the ordinate axis=the remaining mass (in %);

FIG. 26 shows the dinitrogen adsorption-desorption isotherms at 77K obtained after activation of the activated charcoal microparticles in the powder state (points of the curve represented by circles) 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)). The specific surface area BET obtained for the activated charcoal powder is 1,556 m²·g⁻¹+/−0.7 and a pore volume of 1.2 cm³·g⁻¹.

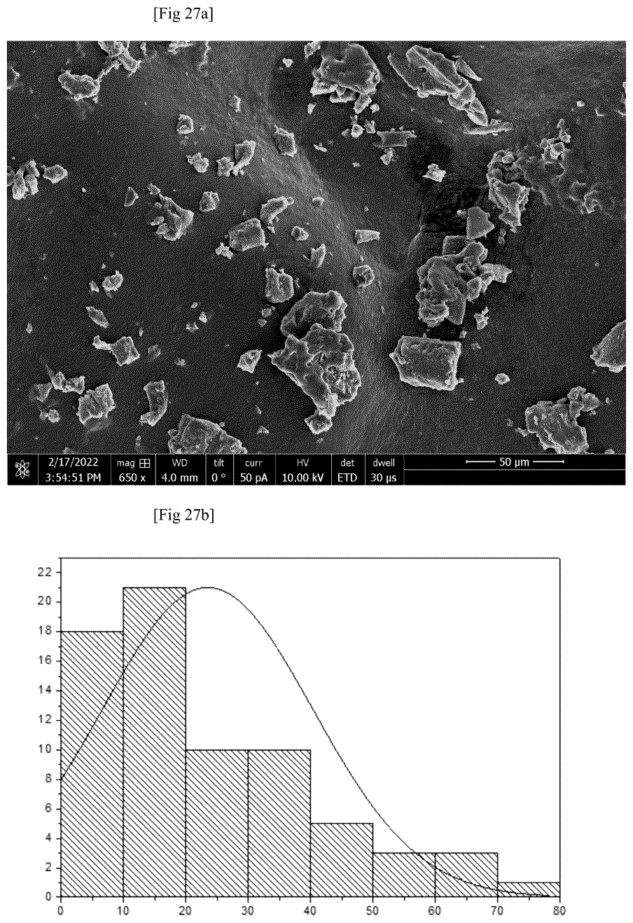

FIG. 27a shows the image of the activated charcoal powder obtained by scanning electron microscopy at a magnification of ×650 and FIG. 27b shows the histogram illustrating the size distribution of the activated charcoal particles, on the ordinate axis: the number, on the abscissa axis: the size of the particles (m).

### Part 2: Formulation of the Paper Membranes Using a Cellulose Matrix and Metal-Organic Frameworks Type Porous Solids: Impact of the Cellulose Matrix on the Final Properties

This part shows the adjustment of the cellulose matrix by the comparison of two types of paper fibres (cotton and softwood) with or without microfibrillated cellulose within the paper membranes.

Paper Membranes with the MIL-100(Fe) Nanoparticles (NPs)

### Example 9: Formulation of the Paper Membranes in the Presence of Cellulose Fibres (Cotton or Softwood) with or without Microfibrillated Cellulose at Different Ratios

100 mg of cotton fibres (originating from crucibles commercialised by Whatman®) are inserted into a blade mill with 10 mL of distilled water and then the fibres are ground for 2 minutes. Afterwards, the fibre solution is added to the solution containing 300 mg of synthetic MIL-100(Fe) nanoparticles in order to ensure optimum dispersion of these within the composite. Finally, the equivalent of 100 mg of microfibrillated cellulose (MFC) (weighted mass of 1,000 mg of MFC added because present at a mass concentration of 10% w/w, Celova® commercialised by Weidmann®) is inserted into the aqueous MOF solution. The mixture is left for 30 minutes and then filtered on a nylon film covering a paper filter. The resulting composite contains 60% w/w of MIL-100(Fe), 20% w/w of softwood fibres and 20% w/w of MFC. It is annotated 60MIL100-NP-20R-20MFC.

Different paper membranes have been made by inserting, or not (comparative examples without MFC), the MFC and by replacing the cotton fibres with the softwood fibres (HWBK™, Kraft Blanchi™ commercialised by the company Canson®). In addition, the MOF proportion has been increased to 75% w/w.

Table 1 (preparation of the cotton fibres/MIL-100(Fe) microparticles mixtures for making of the paper membranes), summarises the compositions of these composites.

TABLE 1

| | NPs MIL- | Cellulose | |
|---|---|---|---|
| | 100(Fe) (%) | fibres (%) | MFC (%) |
| 60MIL100- | 60% w/w | 40% w/w | 0% w/w |
| 40R | 300 mg | Softwood | MFC |
| | | (m = 200 mg) | |
| 60MIL100- | 60% w/w | 20% w/w | 20% w/w |
| 20R-20MFC | 300 mg | Softwood | MFC |
| | | (m = 100 mg) | (m = 100 mg) |
| 60MIL100- | 60% w/w | 40% w/w | 0% w/w |
| 40C | 300 mg | cotton | MFC |
| | | (m = 100 mg) | |
| 60MIL100- | 60% w/w | 20% w/w | 20% w/w |
| 20C-20MFC | 300 mg | cotton | MFC |
| | | (m = 100 mg) | (m = 100 mg) |
| 75MIL100- | 75% w/w | 12.5% w/w | 12.5% w/w |
| 12.5R-12.5MFC | 375 mg | Softwood | MFC |
| | | (m = 62.5 mg) | (m = 62.5 mg) |

Results—Paper Membranes Formulated with the MIL-100(Fe) Nanoparticles

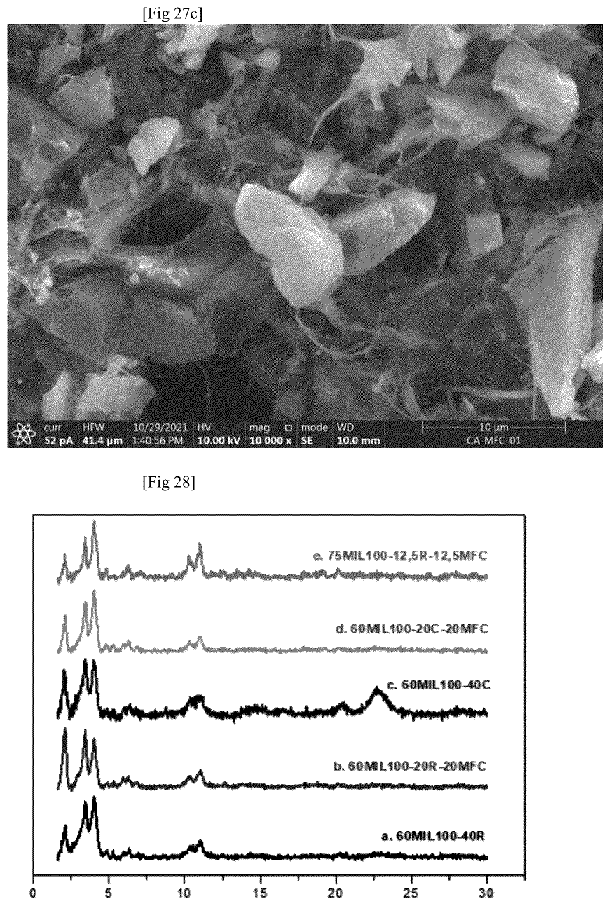

The results are summarised in FIGS. 28-30:

FIG. 28 shows the X-ray diffractograms of the paper membranes formulated with the nanoparticles of MIL-100(Fe): 60MIL100-40R (curve a), 60MIL100-20R-20MFC (curve b), 60MIL100-40C (curve c), 60MIL100-20C-20MFC (curve d), 75MIL100-12.5R-12.5MFC (curve e), (λ_{Cu}≈1.5406 Å), on the ordinate axis: arbitrary relative intensity (a.u.), on the abscissa axis: 2-theta (deg.);

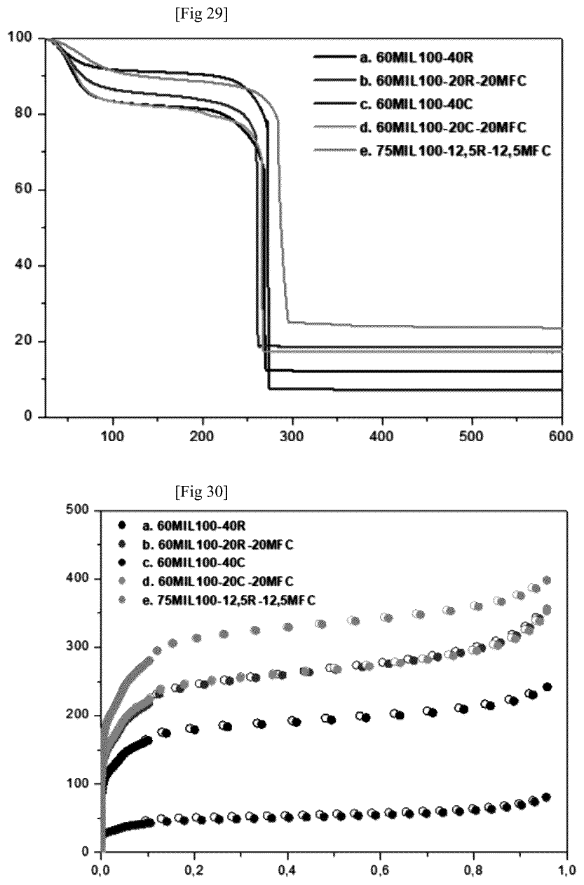

FIG. 29 shows the thermogravimetric analyses (in air, heating rate of 5° C./minute) of these paper membranes formulated with the MIL-100(Fe) nanoparticles. The loss of mass Pm (in %) is represented as a function of the temperature T (in ° C., on the abscissa axis): on the ordinate axis=the remaining mass (in %);

FIG. 30 shows the dinitrogen adsorption-desorption isotherms at 77K obtained after activation of the paper membranes formulated with the MIL-100(Fe) nanoparticles at 150° C. overnight, on the ordinate axis: N₂ volume (cm³·g⁻¹), on the abscissa axis: Relative Pressure (the solid circles correspond to the adsorption, the circles to the desorption; (nanoparticles grain size distribution) (P₀=1 atm.)).

Paper Membranes with the MIL-100(Fe) Microparticles

### Example 10: Formulation of the Paper Membranes in the Presence of Cellulose Fibres (Softwood Pulp) with or without Microfibrillated Cellulose

62.5 mg of softwood pulp (HWBK™) are inserted into a blade mill with 30 mL of distilled water and then the fibres are ground for 2 minutes. 30 mL more of distilled water are added to this suspension. The resulting solution of fibres is passed to the ultrasound probe for 5 minutes in order to neatly separate the clusters of fibres (it is also possible to work in a larger volume of water in order to eliminate this step). The equivalent of 62.5 mg of microfibrillated cellulose (MFC) (weighted mass of 625 mg of MFC added because present at a mass concentration of 10% w/w, Celova® commercialised by Weidmann®) is inserted into the aqueous fibre solution and the mixture is stirred for 15 minutes. Concomitantly, the equivalent of 375 mg of MIL-100(Fe) microparticles (depending on the amount of solvent contained in the pores) is dispersed in an ultrasonic bath in 10 mL of distilled water for 10 minutes. The suspension is added to the fibrous solution and left under stirring for 15 minutes (300 rpm). The mixture is filtered on a nylon film covering a paper filter. The resulting paper membrane with a diameter of 7 cm contains 75% w/w of MIL-100(Fe), 12.5% w/w of softwood fibres and 12.5% of MFC. It is annotated 75MIL100-12.5R-12.5MFC.

Paper membranes have been made with or without MFC (comparative examples without MFC), while keeping constant the proportion of MIL-100(Fe) within the composite (75% w/w).

Table 2 (Preparation of the softwood fibres/MFC/MIL-100 microparticles mixtures for making of the paper membranes), summarises the compositions of these membranes.

TABLE 2

| | MIL-100(Fe) | Cotton fibres (%) | MFC (%) |
|---|---|---|---|
| 75MIL100- | 75% w/w | 18.75% w/w | 0% w/w |
| 25R | (or m = 375 g) | (m = 125 mg) | |
| 75MIL100- | 75% w/w | 12.5% w/w | 12.5% w/w |
| 12.5R-12.5MFC | (or m = 375 mg) | (m = 62.5 mg) | (m = 62.5 mg) |

Results—Paper Membranes Formulated with the MIL-100(Fe) Microparticles

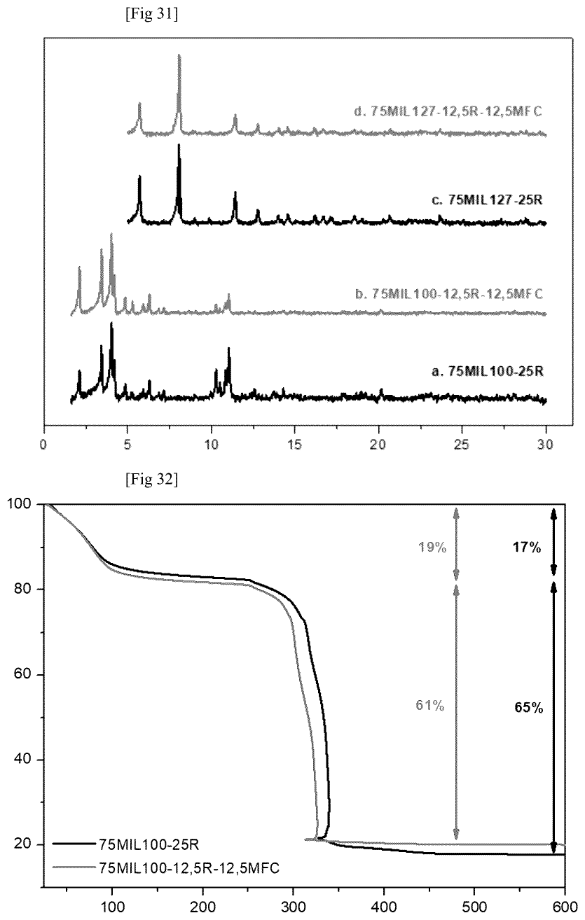

The results are summarised in FIGS. 31-33:

FIG. 31 shows the X-ray diffractograms of the paper membranes formulated with the microparticles of MIL-100(Fe): 75MIL100-25R (curve a) and 75MIL100-12.5R-12.5MFC (curve b) as well as with the microparticles of MIL-127(Fe): 75MIL127-25R (curve c) and 75MIL127-12.5R-12.5MFC (curve d) (λ_{Cu}≈1.5406 Å), on the ordinate axis: arbitrary relative intensity (a.u.), on the abscissa axis: 2-theta (deg.);

FIG. 32 shows the thermogravimetric analysis (in air, heating rate of 5° C./minute) of the paper membranes formulated with the microparticles of MIL-100(Fe): 75MIL100-25R (curve a) and 75MIL100-12.5R-12.5MFC (curve b). The loss of mass Pm (in %) is represented as a function of the temperature T (in ° C., on the abscissa axis): on the ordinate axis=the remaining mass (in %);

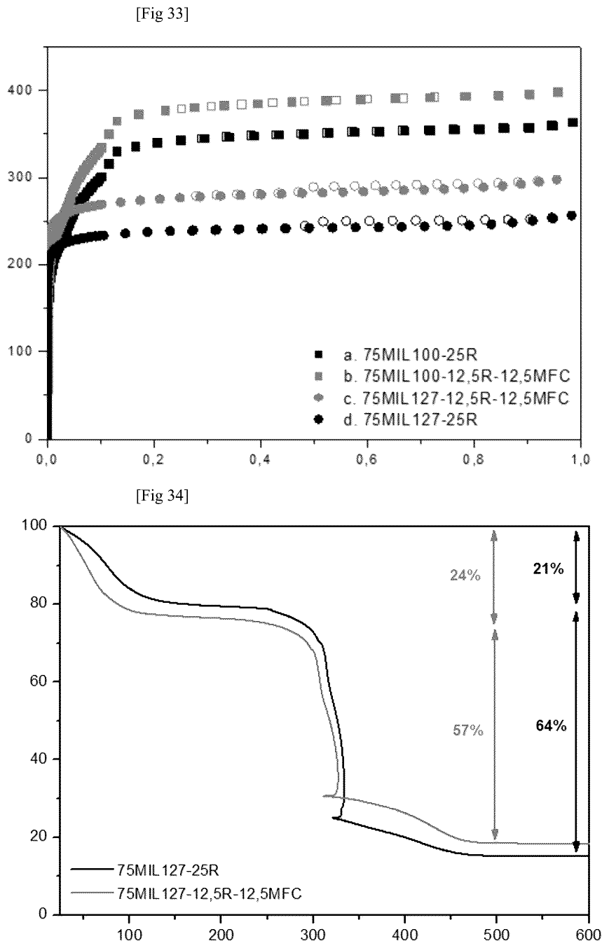

FIG. 33 shows the dinitrogen adsorption-desorption isotherms at 77K obtained after activation of the paper membranes formulated with the microparticles MIL-100(Fe): 75MIL100-25R (isotherm a) and 75MIL100-12.5R-12.5MFC (isotherm b) as well as with the microparticles MIL-127(Fe): 75MIL127-25R (isotherm c) and 75MIL127-12.5R-12.5MFC (isotherm d) at 150° C. overnight, on the ordinate axis: N₂ volume (cm³·g⁻¹), on the abscissa axis: Relative Pressure (the solid circles correspond to the adsorption, the circles to the desorption; (microparticles grain size distribution) (P₀=1 atm.)).

Paper Membranes with the MIL-127(Fe) Microparticles

### Example 11

62.5 mg of softwood pulp (HWBK™) are inserted into a blade mill with 30 mL of distilled water and then the fibres are ground for 2 minutes. 30 mL more of distilled water are added to this suspension. The resulting solution of fibres is passed to the ultrasound probe for 5 minutes in order to neatly separate the clusters of fibres (it is also possible to work in a larger volume of water in order to eliminate this step). The equivalent of 62.5 mg of microfibrillated cellulose (MFC) (weighted mass of 625 mg of MFC added because present at a mass concentration of 10% w/w, Celova® commercialised by Weidmann®) is inserted into the aqueous fibre solution and the mixture is stirred for 15 minutes. Concomitantly, the equivalent of 375 mg of MIL-127(Fe) microparticles (depending on the amount of solvent contained in the pores) is dispersed in an ultrasonic bath in 10 mL of distilled water for 10 minutes. The suspension is added to the fibrous solution and left under stirring for 15 minutes (300 rpm). The mixture is filtered on a nylon film covering a paper filter. The resulting paper membrane with a diameter of 7 cm contains 75% w/w of MIL-127(Fe), 12.5% w/w of softwood fibres and 12.5% of MFC. It is annotated 75MIL127-12.5R-12.5MFC.

Paper membranes have been made with or without MFC (comparative examples without MFC), while keeping constant the proportion of MIL-127(Fe) within the composite (75% w/w).

Table 3 (Preparation of the softwood fibres/MFC/MIL-100 microparticles mixtures for making of the paper membranes), summarises the compositions of the composites.

TABLE 3

| | MIL-127(Fe) | Cotton fibres (%) | MFC (%) |
|---|---|---|---|
| 75MIL127- | 75% w/w | 18.75% w/w | 0% w/w |
| 25R | (or m = 375 g) | (m = 125 mg) | |
| 75MIL127- | 75% w/w | 12.5% w/w | 12.5% w/w |
| 12.5R-12.5MFC | (or m = 375 mg) | (m = 62.5 mg) | (m = 62.5 mg) |

Results—Paper Membranes Formulated with the MIL-127(Fe) Microparticles

The results are summarised in FIGS. 31 and 33-34:

FIG. 31 shows the X-ray diffractograms of the paper membranes formulated with the microparticles of MIL-100(Fe): 75MIL100-25R (curve a) and 75MIL100-12.5R-12.5MFC (curve b) as well as with the microparticles of MIL-127(Fe): 75MIL127-25R (curve c) and 75MIL127-12.5R-12.5MFC (curve d) (λ_{Cu}≈1.5406 Å), on the ordinate axis: arbitrary relative intensity (a.u.), on the abscissa axis: 2-theta (deg.);

FIG. 33 shows the dinitrogen adsorption-desorption isotherms at 77K obtained after activation of the paper membranes formulated with the microparticles MIL-100(Fe): 75MIL100-25R (isotherm a) and 75MIL100-12.5R-12.5MFC (isotherm b) as well as with the microparticles MIL-127(Fe): 75MIL127-25R (isotherm c) and 75MIL127-12.5R-12.5MFC (isotherm d) at 150° C. overnight, on the ordinate axis: N₂ volume (cm³·g⁻¹), on the abscissa axis: Relative Pressure (the solid circles correspond to the adsorption, the circles to the desorption; (microparticles grain size distribution) (P₀=1 atm.));

FIG. 34 shows the thermogravimetric analysis (in air, heating rate of 5° C./minute) of the paper membranes formulated with the microparticles of MIL-127(Fe)75MIL127-25R (curve a) and 75MIL127-12.5R-12.5MFC (curve b). The loss of mass Pm (in %) is represented as a function of the temperature T (in ° C., on the abscissa axis): on the ordinate axis=the remaining mass (in %).

Part 3: Mechanical Properties of the Paper Membranes Made from MOF-Type Porous Solids

The impact of the adjustment of the cellulose matrix on the mechanical properties of the paper membranes. The characterisation of these mechanical properties has been performed by tensile strength measurements using an Adamel Lhomargy® (DY20-N™ 100 dN force sensor) universal testing machine. Each test specimen had a length of 10 cm for a width of 1.5 cm. The tensile zone was located over a length of 5 cm (jaw-to-jaw distance) with an elongation rate of 50 mm/min and a detection at breakage set at 3%. The samples have been preconditioned for at least 24 h at 25° C. and 50% relative humidity and the tests have been carried out according to these same conditions. The measurement has been repeated 5 times for each sample.

Paper Membranes with the MIL-100(Fe) Microparticles

### Example 12: Formulation of the Paper Membrane with the Cotton Fibres and the Microfibrillated Cellulose at Different Ratios

1.03 g of cotton fibres (originating from thimbles commercialised by Whatman®) have been dispersed using a blade mill in 1 L of distilled water and then redispersed in a volume of 4 L of distilled water and left under stirring. 11.46 g of microfibrillated cellulose (MFC) with a concentration equal to 3% w/w in water (Celova® commercialised by Weidmann®) has been added to the mixture. Then, 4.125 g of MIL-100 microparticles (synthesis explained in Part 1, the mass has been adjusted depending on the amount of solvent contained in the pores) have been placed in 250 mL of distilled water and placed in an ultrasonic bath for 15 minutes in order to properly disperse the aggregates. The obtained solution is added to the mixture of fibres and left under stirring for 15 minutes. Afterwards, the solution is filtered through a 1 micron canvas (commercialised by Buisine®) using a Rapid Köthen™ former apparatus (manufactured by Frank®). Afterwards, the obtained paper membrane with a diameter of 20 cm is dried under vacuum at 85° C. for 30 minutes using a dryer attached to the former machine. The obtained composite contains 75% w/w of MIL-100(Fe) microparticles, 6.25% w/w of cotton fibres and 18.75% w/w of MFC and is denoted MIL100-75C-25MFC.

Different paper membranes have been made by varying the cotton fibres/MFC ratio.

Table 4 (Preparation of the cotton fibres/MIL-100 microparticles mixtures for making of the paper membranes and the characterisation of their mechanical properties), summarises the compositions of the composites.

TABLE 4

| | MIL-100(Fe) | Cotton fibres (%) | MFC (%) |
|---|---|---|---|
| MIL100- | 75% w/w | 18.75% w/w | 6.25% w/w |
| 75C-25MFC | (or m = 4.125 g) | (m = 1.03 g) | (m = 11.46 g) |
| MIL100- | 75% w/w | 12.5% w/w | 12.5% w/w |
| 50C-50MFC | (or m = 4.125 g) | (m = 0.687 g) | (m = 22.92 g) |
| MIL100- | 75% w/w | 6.25% w/w | 18.75% w/w |
| 25C-75MFC | (or m = 4.125 g) | (m = 0.344 g) | (m = 34.375 g) |

Results—Paper Membrane Formulated with the MIL-100(Fe) Microparticles and the Cotton Fibres

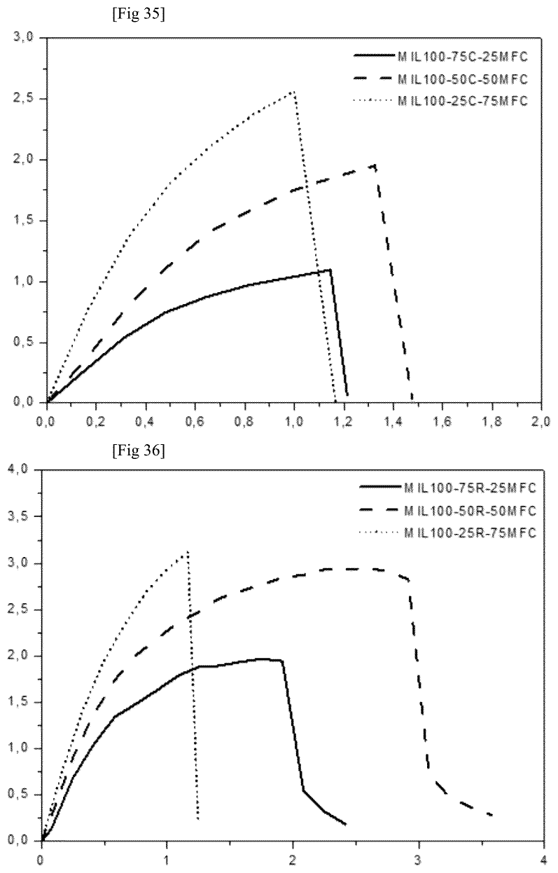

FIG. 35 and Table 5 show the obtained results.

FIG. 35 shows the stress-strain curves obtained by tensile testing of the paper membranes (a) MIL100-75C-25MFC, (b) MIL100-50C-50MFC and (c) M-5100-25C-75MFC (on the ordinate axis: the stress (Mpa), on the abscissa axis: the elongation (0%)).

Table 5 summarises the mechanical data deduced from the stress-strain curves corresponding to the Young's modulus (on the ordinate axis, Mpa), to the maximum force before breakage and the deformation at breakage (on the ordinate axis, %) of the different paper membranes MIL100-75C-25MFC, MIL100-50C-50MFC and MIL100-25C-75MFC;

TABLE 5

| | MIL100- | MIL100- | MIL100- |
|---|---|---|---|
| | 75C-25MFC | 50C-50MFC | 25C-75MFC |
| Young's modulus (Mpa) | 183.4 | 280.3 | 429.4 |
| Standard deviation | 27.9 | 26.7 | 46.2 |
| Maximum force (N) | 6.7 | 11.8 | 18.1 |
| Standard deviation | 0.6 | 1.1 | 1 |
| Deformation (%) | 1.3 | 1.2 | 1.1 |
| Standard deviation | 0.4 | 0.2 | 0.1 |

Table 5 summarises the mechanical data of the different paper membranes with the MIL-100(Fe) microparticles and the cotton fibres

### Example 13: Formulation of the Paper Membrane with the Softwood Fibres and the Microfibrillated Cellulose at Different Ratios

The steps of preparing the paper membranes are identical to those described hereinabove but softwood pulp (HWBK™, Kraft Blanchi™ supplied by Canson®) has been used as a source of cellulose fibres instead of cotton fibres.

Different paper membranes have been made by varying the softwood fibres/MFC ratio.

Table 6 (Preparation of fibres/MIL-100 mixtures for making of the paper membranes), summarises the compositions of the composites.

TABLE 6

| | MIL-100(Fe) | Softwood fibres | MFC |
|---|---|---|---|
| MIL100- | 75% w/w | 18.75% w/w | 6.25% w/w |
| 75R-25MFC | (or m = 4.125 g) | (m = 1.03 g) | (m = 11.46 g) |
| MIL100- | 75% w/w | 12.5% w/w | 12.5% w/w |
| 50R-50MFC | (or m = 4.125 g) | (m = 0.687 g) | (m = 22.92 g) |
| MIL100- | 75% w/w | 6.25% w/w | 18.75% w/w |
| 25R-75MFC | (or m = 4.125 g) | (m = 0.344 g) | (m = 34.375 g) |

Results—Paper Membranes Formulated with the MIL-100(Fe) Microparticles and the Softwood Fibres

FIG. 36 and Table 7 show the obtained results.

FIG. 36 shows the stress-strain curves obtained by tensile testing of the paper membranes (a) MIL100-75R-25MFC, (b) MIL100-50R-50MFC and (c) MIL100-25R-75MFC, (on the ordinate axis: the stress (Mpa), on the abscissa axis: the elongation (%)).

Table 7 summarises the mechanical data deduced from the stress-strain curves corresponding to the Young's modulus (on the ordinate axis, Mpa), at the maximum force before breakage and the deformation at breakage (on the ordinate axis, %) of the different paper membranes MIL100-75R-25MFC, MIL100-50R-50MFC and MIL100-25R-75MFC;

TABLE 7

| | MIL100- | MIL100- | MIL100- |
|---|---|---|---|
| | 75R-25MFC | 50R-50MFC | 25R-75MFC |
| Young's modulus (Mpa) | 296 | 384.3 | 434 |
| Standard deviation | 31.5 | 29.9 | 20.7 |
| Maximum force (N) | 13.7 | 19.5 | 19.7 |
| Standard deviation | 1 | 0.4 | 1 |
| Deformation (%) | 2.2% | 2.6% | 1.3% |
| Standard deviation | 0.6 | 0.4 | 0.2 |

Table 7 summarises the mechanical data of the different paper membranes with the MIL-100(Fe) microparticles and the softwood fibres.

Paper Membranes with the MIL-127(Fe) Microparticles

### Example 14: Formulation of the Paper Membrane in the Presence of Cotton Fibres and Microfibrillated Cellulose at Different Ratios

687 mg of softwood fibres (HWBK™, Kraft Blanchi™ commercialised by Canson®) have been dispersed using a blade mill in 1 L of distilled water and then redispersed in a volume of 4 L of distilled water and left under stirring. 22.92 g of microfibrillated cellulose (MFC) with a concentration equal to 3% w/w in water (Celova® commercialised by Weidmann®) has been added to the mixture. Then, the equivalent of 4.125 g of MIL-127 microparticles (synthesis explained in Example 3, the mass has been adjusted depending on the amount of solvent contained in the pores) have been placed in 250 mL of distilled water and placed in an ultrasonic bath for 15 minutes in order to properly disperse the aggregates. The obtained solution is added to the mixture of fibres and left under stirring for 15 minutes. Afterwards, the solution is filtered through a 1 micron canvas (commercialised by Buisine) using a Rapid Köthen™ former apparatus (commercialised by Frank™). Afterwards, the obtained paper membrane with a diameter of 20 cm is dried under vacuum at 85° C. for 30 minutes using a dryer attached to the former machine. The obtained composite contains 75% w/w of MIL-127(Fe) microparticles, 12.5% w/w of softwood fibres and 12.5% w/w of MFC and is denoted MIL127-50R-50MFC.

Different paper membranes have been made by varying the softwood fibres/MFC ratio (comparative examples without MFC). The table hereinbelow summarises the compositions of these composites.

Table 8 (Preparation of the softwood fibres/MIL-127 microparticles mixtures for making of the paper membranes), summarises the compositions of the composites.

TABLE 8

| | | Softwood | |
|---|---|---|---|
| | MIL-127(Fe) | fibres (%) | MFC (%) |
| MIL127- | 75% w/w | 25% w/w | 0% w/w |
| 100R | (or m = 4.125 g) | (m = 1.31 g) | |
| MIL127- | 75% w/w | 18.75% w/w | 6.25% w/w |
| 75R-25MFC | (or m = 4.125 g) | (m = 1.013 g) | (m = 11.46 g) |
| MIL127- | 75% w/w | 12.5% w/w | 12.5% w/w |
| 50R-50MFC | (or m = 4.125 g) | (m = 687 mg) | (m = 687 mg) |

Results—Mechanical Characteristics—Paper Membranes Formulated with the MIL-127(Fe) Microparticles and the Softwood Fibres

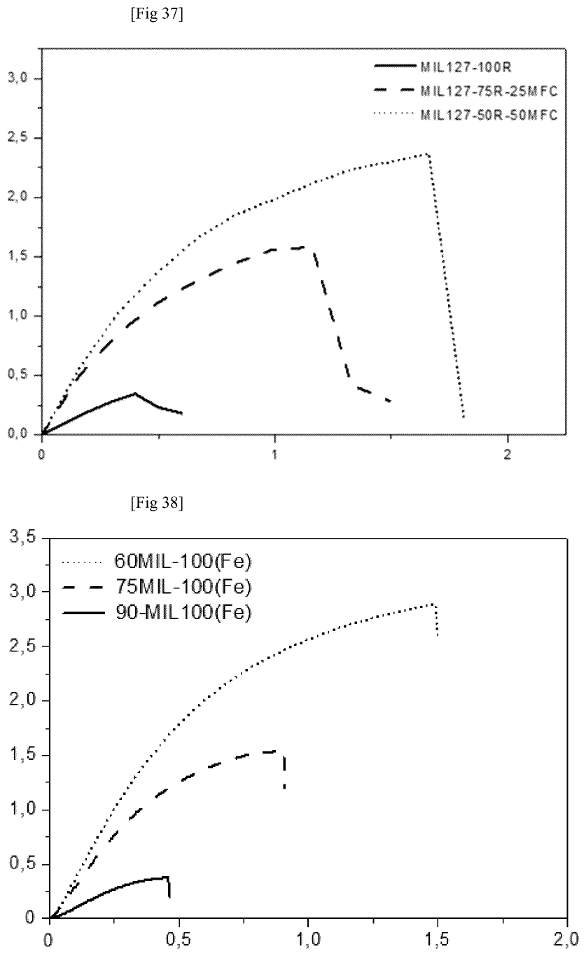

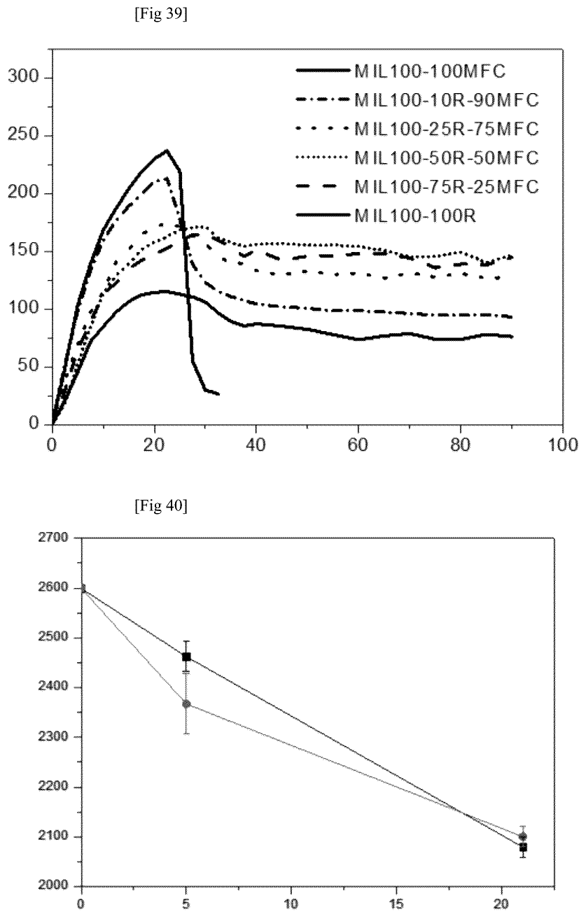

FIG. 37 and Table 9 show the obtained results.

FIG. 37 shows the stress-strain curves obtained by tensile testing of the paper membranes (a) MIL127-100R, (b) MIL127-75R-25MFC and (c) MIL127-50R-50MFC (on the ordinate axis: the stress (Mpa), on the abscissa axis: the elongation (%));

Table 9 summarises the mechanical data deduced from the stress-strain curves corresponding to the Young's modulus (on the ordinate axis, Mpa), at the maximum force before breakage and the deformation at breakage (on the ordinate axis, %) of the different paper membranes MIL127-100R, MIL127-75R-25MFC, MIL127-50R-50MFC;

TABLE 9

| | MIL127- | MIL127- | MIL127- |
|---|---|---|---|
| | 100R | 75R-25MFC | 50R-50MFC |
| Young's modulus (Mpa) | 120 | 267 | 332 |
| Standard deviation | 22.8 | 33 | 16 |
| Maximum force (N) | 2.2 | 9.8 | 14.5 |
| Standard deviation | 0.3 | 1.1 | 0.8 |
| Deformation (%) | 0.4 | 1.3 | 1.7 |
| Standard deviation | 0.1 | 0.2 | 0.1 |

Table 9 summarises the mechanical data of the different paper membranes with the MIL-127(Fe) microparticles and the softwood fibres

Paper Membranes with the MIL-100(Fe) Nanoparticles

### Example 15: Formulation of the Paper Membrane with a Softwood:MFC Ratio=25:75 at Different Percentages of Nano-MIL-100(Fe)

0.218 g of softwood fibres (HWBK™, Kraft Blanchi™ commercialised by Canson®) have been dispersed using a bladed mill in 1 L of distilled water and then redispersed in a volume of 4 L of distilled water and stirred. 21.9 g of microfibrillated cellulose (MFC) with a concentration equal to 3% w/w in water (Celova® commercialised by Weidmann®) has been added to the mixture. Then, 2.622 g of MIL-100(Fe) nanoparticles (synthesis explained in Part 1, the mass has been adjusted depending on the amount of solvent contained in the pores) have been placed in 250 mL of distilled water and placed in an ultrasonic bath for 15 minutes in order to properly disperse the aggregates. The obtained solution is added to the mixture of fibres and left under stirring for 15 minutes. Afterwards, the solution is filtered through a 1 micron canvas (commercialised by Buisine©) using a Rapid Köthen™ former apparatus (manufactured by Frank®). Afterwards, the obtained paper membrane with a diameter of 20 cm is dried under vacuum at 85° C. for 30 minutes using a dryer attached to the former machine. The obtained composite contains 75% w/w of MIL-100(Fe) nanoparticles, 6.25% w/w of softwood fibres and 18.75% w/w of MFC and is denoted 75MIL100.

Different paper membranes have been prepared by varying the percentage by weight of MIL-100(Fe).

Table 10 (Preparation of the fibres/MIL-100 nanoparticles mixtures for making of the paper membranes and the characterisation of their mechanical properties), summarises the compositions of the composites while keeping the total mass of the composite constant (3.496 g). [Table 10]

TABLE 10

| | MIL-100(Fe) | Cotton fibres (%) | MFC (%) |
|---|---|---|---|
| 60MIL100 | 60% w/w | 10% w/w | 30% w/w |
| | (or m = 2.622 g) | (m = 0.35 g) | (m = 35 g) |
| 75MIL100 | 75% w/w | 6.25% w/w | 18.75% w/w |
| | (or m = 2.622 g) | (m = 0.218 g) | (m = 21.9 g) |
| 90MIL100 | 90% w/w | 2.5% w/w | 7.5% w/w |
| | (or m = 2.622 g) | (m = 0.087 g) | (m = 8.7 g) |

Results—Paper Membrane Formulated with the MIL-100(Fe) Nanoparticles and Softwood Fibres

FIG. 38 and Table 11 show the obtained results.

FIG. 38 shows the stress-strain curves obtained by tensile testing of the paper membranes (a) 60MIL100, (b) 75MIL100 and (c) 90MIL100 (on the ordinate axis: stress (Mpa), on the abscissa axis: elongation (0%)).

Table 11 summarises the mechanical data deduced from the stress-strain curves corresponding to the Young's modulus (on the ordinate axis, Mpa), to the maximum force before breakage and the deformation at breakage (on the ordinate axis, %) of the different paper membranes 60MIL100, 75MIL100 and 90MIL100;

TABLE 11

| | 60MIL100 | 75MIL100 | 90MIL100 |
|---|---|---|---|
| Young's modulus (Mpa) | 427 | 336 | 81 |
| Standard deviation | 17 | 14 | 12 |
| Maximum force (N) | 13.4 | 7.4 | 1.6 |
| Standard deviation | 0.6 | 0.2 | 0.2 |
| Deformation (%) | 1.5 | 0.9 | 0.4 |
| Standard deviation | 0.06 | 0.06 | 0.09 |

Table 11 summarises the mechanical data of the different paper membranes with the MIL-100(Fe) nanoparticles, the MFC and the softwood fibres

### Part 4: Determination of an Optimum Long Cellulose Fibre:MFC Ratio

The impact of the adjustment of the cellulose matrix on the mechanical properties and more specifically the flexibility of the paper membranes has been studied. The characterisation of these mechanical properties has been performed by two-point bending resistance measurements using a Büchel Van Der Korput bending machine. Each sample had a length of 5 cm for a width of 3.8 cm. The samples have been preconditioned for at least 24 h at 25° C. and 50% relative humidity and the tests have been carried out according to these same conditions. The measurement has been repeated 3 times for each sample. The bending stiffness calculations have been carried out according to the standard ISO5628:2019.

Paper Membranes with the MIL-100(Fe) Microparticles

### Example 16: Formulation of the Paper Membrane with the Softwood Fibres and Microfibrillated Cellulose at Different Ratios

The steps of preparing the paper membranes, the used porous solid and selected fibres are identical to those described in Example 13.

Different paper membranes have been prepared by varying the softwood fibre/MFC ratio (comparative example without MFC-MIL100-100R).

Table 12 (Preparation of the softwood fibres/MIL-100(Fe) microparticles mixtures for making paper membranes and characterisation of their flexibility), summarises the compositions of the composites.

TABLE 12

| | | Softwood | |
|---|---|---|---|
| | MIL-100(Fe) | fibres (%) | MFC (%) |
| MIL100- | 75% w/w | 25% w/w | 0% w/w |
| 100R | (or m = 2.622 g) | (m = 0.874 g) | (m = 0 g) |
| MIL100- | 75% w/w | 18.75% w/w | 6.25% w/w |
| 75R-25MFC | (or m = 2.622 g) | (m = 0.656 g) | (m = 7.26 g) |
| MIL100- | 75% w/w | 12.5% w/w | 12.5% w/w |
| 50R-50MFC | (or m = 2.622 g) | (m = 0.437 g) | (m = 14.56 g) |
| MIL100- | 75% w/w | 6.25% w/w | 18.75% w/w |
| 25R-75MFC | (or m = 2.622 g) | (m = 0.218 g) | (m = 21.86 g) |
| MIL100- | 75% w/w | 2.5% w/w | 22.5% w/w |
| 10R-25MFC | (or m = 2.622 g) | (m = 0.087 g) | (m = 26.2 g) |
| MIL100- | 75% w/w | 0% w/w | 25% w/w |
| 100MFC | (or m = 2.622 g) | (m = 0 g) | (m = 29.1 g) |

Results—Paper Membranes Formulated with the MIL-100(Fe) Microparticles and the Softwood Fibres

FIG. 39 and Table 13 show the obtained results.

FIG. 39 shows the force vs. bending angle curves obtained by bending tests of two points of the paper membranes (a) MIL100-100R (en bas), (b) MIL100-75R-25MFC, (c) MIL100-50R-50MFC, (d) MIL100-25R-75MFC, (e) MIL100-10R-90MFC and (f) MIL100-100MFC (at the op) (on the ordinate axis: force (mN), on the abscissa axis: bending angle (°)).

Table 13 summarises the mechanical data deduced from the force vs. bending angle curves corresponding to the bending stiffness (N·mm), at the maximum force before plastic deformation (on the ordinate axis, N), at breakage, or not, of the different paper membranes MIL100-100R, MIL100-75R-25MFC, MIL100-50R-50MFC, MIL100-25R-75MFC, MIL100-10R-90MFC, MIL100-100MFC;

TABLE 13

| | | MIL100- | MIL100- | MIL100- | MIL100- | |
|---|---|---|---|---|---|---|
| | MIL100- | 75R- | 50R- | 25R- | 10R- | MIL100- |
| | 100R | 25MFC | 50MFC | 75MFC | 90MFC | 100MFC |
| Bending | 0.45 | 0.51 | 0.54 | 0.57 | 0.77 | 0.84 |
| stiffness (N · mm) | | | | | | |
| Standard | 0.02 | 0.03 | 0.02 | 0.03 | 0.06 | 0.008 |
| deviation | | | | | | |
| Maximum force | 115 | 152 | 163 | 173 | 213 | 237 |
| (N) | | | | | | |
| Standard | 9 | 12 | 10 | 4 | 10 | 1 |
| deviation | | | | | | |
| Breakage of the | No | No | No | No | Yes | Yes |
| paper membrane | | | | | | |

Table 13 summarises the mechanical flexibility data of the different paper membranes with the MIL-100(Fe) microparticles and the softwood fibres.

### Part 5: Study of the Impact of the MIL-100(Fe) Paper Membranes on the Cellulose by Accelerated Ageing

The objective of this part is to determine whether the paper membrane containing 75% w/w of MIL-100(Fe) (MIL100-50R-50MFC) would have an effect on the cellulose. Indeed, this composite could release volatile organic compounds (VOCs) that could alter the cellulose. These tests have been adapted to the standard ISO 16245, given in the reference [20].

### Example 17: Ageing Tests

Five flasks made of borosilicate glass with a unit volume of 140 cm³ and able to be hermetically closed using a silicone/Teflon® cap and septum have been conditioned for at least 48 h at 50% relative humidity and a temperature of 25° C. Each of these tubes contains a mass of cellulose paper with no Whatman® 1 filler (control paper) equal to 250 mg and a hygro-button allowing controlling the temperature and the relative humidity over time. These samples have been preconditioned (50% RH and 25° C.) and then cut into fine strips and placed in a pill organiser, their degradation will be assessed after ageing. Two control flasks are established by inserting 4.2 g of Whatman® 1 paper cut into the form of preconditioned test specimens. The control flasks are then ready to be closed. Moreover, three other flasks have been prepared with 766 mg of paper membranes containing 75% w/w of MIL-100(Fe) microparticles cut into test specimens and preconditioned. Afterwards, the flasks are hermetically closed. The five flasks are arranged in an oven at 80° C. for 5 days. After incubation, the degree of polymerisation of the strips of Whatman® 1 papers contained in the pill organisers is assessed by viscometry (adapted from the international standard IEC 60450 [21]) using a flow viscometer (from the Cannon-Fenske™ brand, Model Routine 100) commercialised by Normalab Analis™)

The test has been repeated with an incubation time at 80° C. equal to 3 weeks (21 days).

Results—Paper Membrane Formulated with the MIL-100(Fe) Microparticles

Cf FIG. 38: FIG. 38 shows the evolution of the degree of polymerisation (on the ordinate axis: degree of polymerisation) of the cellulose after different ageing times (on the abscissa axis: ageing time in days) with or without a paper membrane, the curve with the square points corresponds to the Whatman control, and the curve with the round points corresponds to the Whatman aged in the presence of the paper membrane.

Part 6: Making of the Paper Membranes from Porous Solids for the VOCs Capture Tests

The same characterisation techniques (XRD, FTIR, ATG and N₂ Adsorption/Desorption at 77K) used and described in part 1 (cf. also the analysis part and experimental protocols) have been used in order to characterise the paper membranes formulated with the powders described in part 1.

Moreover, the observation of the surface topography of the samples has been performed by scanning electron microscopy using an ESEM Quattro™ (commercialised by ThermoFischer Scientific™)

Paper Membranes with the MIL-100(Fe) Microparticles

### Example 18: Formulation of the Paper Membrane

62.5 mg of softwood pulp (HWBK™, bleached Kraft™ pulp supplied by Canson®) are inserted into a blade mill with 30 mL of distilled water and then the fibres are ground for 2 minutes. 30 mL more are added to this suspension. The resulting fibre solution is passed to the ultrasound probe for 5 minutes in order to neatly separate the clusters of fibres (it is also possible to work in a larger volume of water in order to eliminate this step). The equivalent of 62.5 mg of microfibrillated cellulose (MFC) (weighted mass of 625 mg of added MFC because present at a mass concentration of 10% w/w, Celova® commercialised by Weidmann®) is inserted into the aqueous fibre solution and the mixture is left under stirring for 15 minutes. At the same time, the equivalent of 375 mg of MIL-100(Fe) microparticles (depending on the amount of solvent contained in the pores) is dispersed in an ultrasound bath in 10 mL of distilled water for 10 minutes. The suspension is added to the fibrous solution and left under stirring for 15 minutes (300 rpm). The mixture is filtered on a nylon film covering a paper filter. The resulting paper membrane with a diameter of 7 cm contains 75% w/w of MIL-100(Fe), 12.5% w/w of softwood fibres and 12.5% w/w of MFC. (After VOC capture, the paper membranes can be regenerated by placing it in distilled water for 3 days, while taking care to change the water 3 times per day)

Results—Paper Membrane Formulated with the MIL-100(Fe) Microparticles

FIGS. 1-4 d compile the results obtained:

FIG. 1 shows the X-ray diffractograms in the form of a paper membrane (cour©(c) at the top) (microparticles grain size distribution) (λ_{Cu}≈1.5406 Å)), on the ordinate axis: arbitrary relative intensity (a.u.), on the abscissa axis: 2-theta deg.);

FIG. 2 shows the thermogravimetric analysis (in air, at a heating rate of 5° C./minute) of the MIL-100(Fe) microparticles thereafter in the form of a paper membrane ((b) in grey). The loss of mass Pm (in %) is represented as a function of the temperature T (in ° C., on the abscissa axis): on the ordinate axis=the remaining mass (in %);

FIG. 3 shows the dinitrogen adsorption-desorption isotherms at 77K obtained after activation of the MIL-100(Fe) microparticles in the form of a paper membrane Example 16 (points of the curve represented by squares) at 150° C. overnight, on the ordinate axis: N₂ volume (cm³·g⁻¹), on the abscissa axis: Relative Pressure (the black points correspond to the adsorption, the white points to the desorption; (microparticles grain size distribution) (P₀=1 atm.)). The obtained specific surface area BET of the MIL-100(Fe) paper membrane is 1,416 m²·g⁻¹+/−1.5;

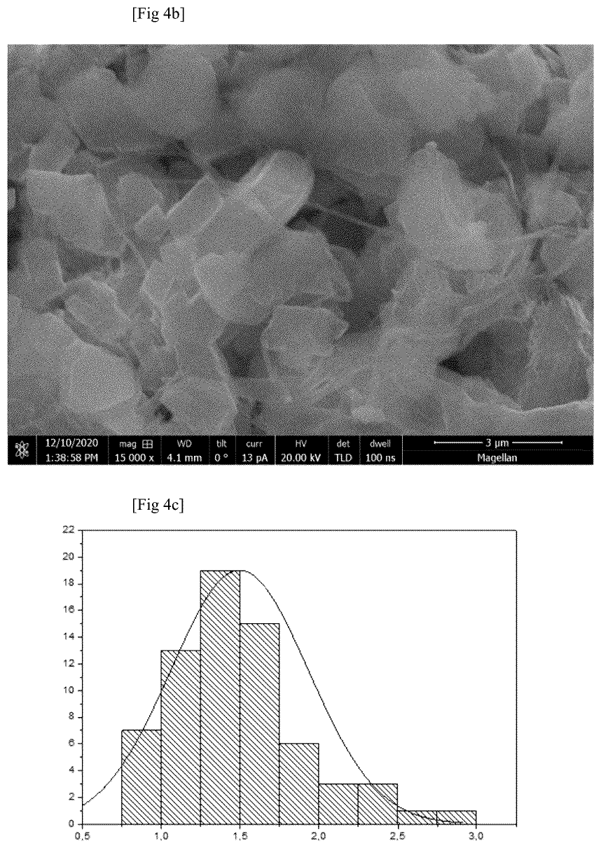

FIGS. 4a and 4b show the images of the paper membrane containing 75% w/w of MIL-100(Fe) microparticles by scanning electron microscopy at different magnifications: (a) ×10,000 and (b) ×15,000 and FIGS. 4c and 4d show histograms illustrating the size distribution of the MIL-100(Fe) particles as well as the size distribution of the fibres, on the ordinate axis: the number, on the abscissa axis: the size of the particles (or fibres) (μm).

Paper Membranes with the MIL-127(Fe) Microparticles

### Example 19: Formulation of the Paper Membrane

The method for formulating the paper membrane is identical to that one described hereinbefore for the MIL-100(Fe) microparticles, by dispersing in an aqueous solution, 375 mg of dry MIL-127(Fe) (and while taking account of the amount of solvent contained in the pores of the solid). The resulting paper membrane with a diameter of 7 cm contains 75% w/w of MIL-127(Fe), 12.5% w/w of softwood fibres and 12, 5% w/w of MFC.

Results—Paper Membranes Formulated with the MIL-127(Fe) Microparticles

FIGS. 8-10 compile the obtained results:

FIG. 8 shows the X-ray diffractograms in the form of a paper membrane (curve (c) at the top) (microparticles grain size distribution) (λ_{Cu}≈1.5406 Å)), on the ordinate axis: arbitrary relative intensity (a.u.), on the abscissa axis: 2-theta (deg.);

FIG. 9 shows the thermogravimetric analysis (in air, at a heating rate of 5° C./minute) of the MIL-127(Fe) microparticles thereafter in the form of a paper membrane ((b) in grey). The loss of mass Pm (in %) is represented as a function of the temperature T (in ° C., on the abscissa axis): on the ordinate axis=the remaining mass (in %);

FIG. 10 shows the dinitrogen adsorption-desorption isotherms at 77K obtained after activation of the MIL-127(Fe) microparticles in the form of a paper membrane Example 17 (points of the curve represented by squares) at 150° C. overnight, on the ordinate axis: N₂ volume (cm³·g⁻¹), on the abscissa axis: Relative Pressure (the black points correspond to the adsorption, the white points to the desorption; (microparticles grain size distribution) (P₀=1 atm.)). The obtained specific surface area BET of the MIL-127(Fe) paper membrane is 1,100.5 m²·g⁻¹+/−0.4;

Paper Membranes with the Al-PDA Nanoparticles

### Example 20: Formulation of the Paper Membrane

The method for formulating the paper membranes is identical to that one described hereinbefore for the MIL-100(Fe) microparticles, by dispersing in an aqueous solution, 375 mg of dry Al-PDA (while taking account of the amount of solvent contained in the pores of the solid). The resulting paper membrane with a diameter of 7 cm contains 75% w/w of Al-PDA, 12.5% w/w of softwood fibres and 12.5% of MFC.

Results—Paper Membrane Formulated with the Al-PDA Nanoparticles

FIGS. 11-14 c compile the obtained results:

FIG. 11 shows the X-ray diffractograms of the Al-PDA nanoparticles in the form of a paper membrane (curve (c) at the top), (nanoparticles grain size distribution) (λ_{Cu}≈1.5406 Å)), on the ordinate axis: arbitrary relative intensity (a.u.), on the abscissa axis: 2-theta (deg.);

FIG. 12 shows the thermogravimetric analysis (in air, at a heating rate of 5° C./minute) of the Al-PDA nanoparticles thereafter in the form of a paper membrane ((b) in grey). The loss of mass Pm (in %) is represented as a function of the temperature T (in ° C., on the abscissa axis): on the ordinate axis=the remaining mass (in %);

FIG. 13 shows the dinitrogen adsorption-desorption isotherms at 77K obtained after activation of the Al-PDA nanoparticles in the form of a paper membrane Example 18 (points of the curve represented by squares) at 200° C. for 5 h, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)). The obtained specific surface area BET of the Al-PDA paper membrane is 794 m²·g⁻¹+/−0.83;

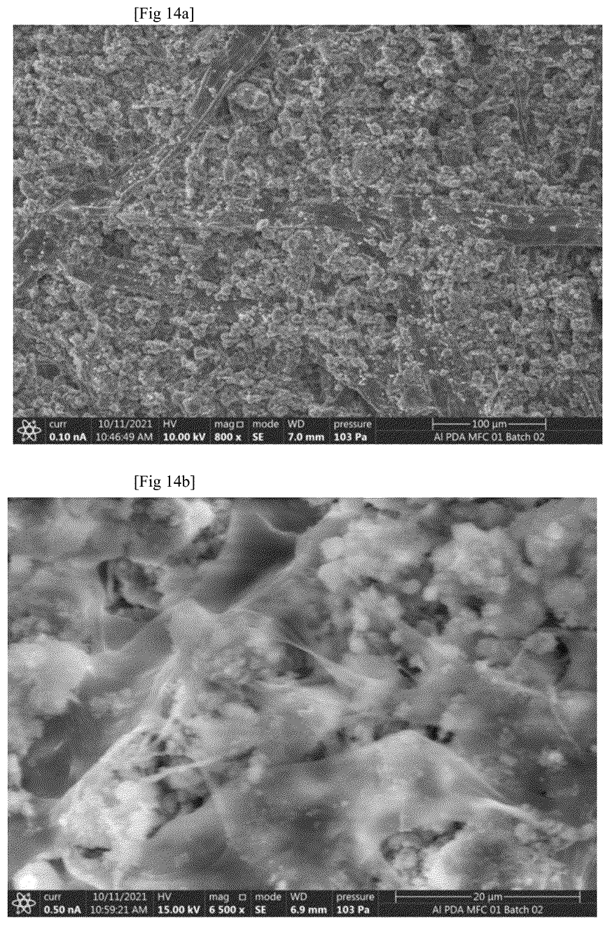

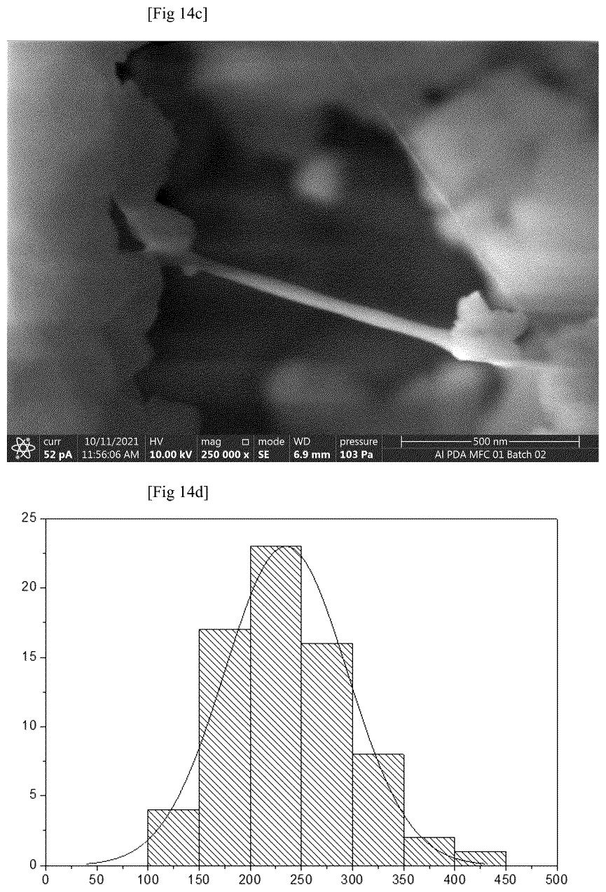

FIGS. 14a, 14b and 14c show the images of the paper membrane containing 75% w/w of Al-PDA nanoparticles obtained by scanning electron microscopy at different magnifications: (a) ×800, (b) ×6,500 and (c) ×250,000 and FIG. 14d shows the histogram of the size distribution of the Al-PDA particles, on the ordinate axis: the number, on the abscissa axis: the size of the particles (nm).

Paper Membranes with the UiO-66(Zr)-2CF₃ Microparticles

### Example 21: Formulation of the Paper Membrane

The method for formulating the paper membrane is identical to that one described hereinbefore for the MIL-100(Fe) microparticles, by dispersing in an aqueous solution, 375 mg of dry UiO-66(Zr)-2CF₃ (while taking account of the amount of solvent contained in the pores of the solid). The resulting paper membrane with a diameter of 7 cm contains 75% w/w of UiO-66(Zr)-2CF₃, 12.5% w/w of softwood fibres and 12, 5% w/w of MFC.

Results—Paper Membranes Formulated with the UiO-66(Zr)-2CF₃ Microparticles

FIGS. 15-17 compile the obtained results:

FIG. 15 shows the X-ray diffractograms of the UiO-66(Zr)-2CF₃ microparticles in the form of a paper membrane (curve (c) at the top), (microparticles grain size distribution) (λ_{Cu}≈1.5406 Å)), on the ordinate axis: arbitrary relative intensity (a.u.), on the abscissa axis: 2-theta (deg.);

FIG. 16 shows the thermogravimetric analysis (in air, heating rate of 5° C./minute) of the UiO-66(Zr)-2CF₃ microparticles in the form of a paper membrane ((b) in grey). The loss of mass Pm (in %) is represented as a function of the temperature T (in ° C., on the abscissa axis): on the ordinate axis=the remaining mass (in %);

FIG. 17 shows the dinitrogen adsorption-desorption isotherm at 77K obtained after activation of the UiO-66(Zr)-2CF₃ microparticles in the form of a paper membrane (points of the curve represented by squares) at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)) the obtained specific surface area BET of the UiO-66-2CF₃(Zr) paper membrane is 685 m²·g⁻¹+/−0.3;

Paper Membranes with the MIL-53(Al)CF₃ Nanoparticles

### Example 22: Formulation of the Paper Membrane

The method for formulating the paper membrane is identical to that one described hereinbefore for the MIL-100(Fe) microparticles, in an aqueous solution, 375 mg of dry MIL53-CF₃ (while taking account of the amount of solvent contained in the pores of the solid). The resulting paper membrane with a diameter of 7 cm contains 75% w/w of MIL-53-CF₃; 12.5% w/w of softwood fibres and 12.5% of MFC.

Results—Paper Membrane Formulated with the MIL-53(Al)-CF₃ Nanoparticles

FIGS. 18-20 compile the obtained results:

FIG. 18 shows the X-ray diffractograms of the MIL-53(Al)-CF₃ nanoparticles in the form of a paper membrane (curve (d) at the top), (nanoparticles grain size distribution) (λ_{Cu}≈1.5406 Å)), on the ordinate axis: arbitrary relative intensity (a.u.), on the abscissa axis: 2-theta (deg.);

FIG. 19 shows the thermogravimetric analysis (in air, heating rate of 5° C./minute) of the MIL-53(Al)-CF₃ nanoparticles in the form of a paper membrane ((b) in grey). The loss of mass Pm (in %) is represented as a function of the temperature T (in ° C., on the abscissa axis): on the ordinate axis=remaining mass (in %);

FIG. 20 shows the dinitrogen adsorption-desorption isotherms at 77K obtained after activation of the MIL-53(Al)-CF₃ nanoparticles as such of Example 6 in the form of a paper membrane of Example 20 (points of the curve represented by squares) at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)) The obtained specific surface area BET of the MIL-53-CF₃(Al) paper membrane is 513 m²·g⁻¹+/−0.766;

Paper Membranes with the Activated Charcoal Microparticles

### Example 23: Formulation of the Paper Membrane

The method for formulating the paper membrane is identical to that one described hereinbefore for the MIL-100(Fe) microparticles, by dispersing in an aqueous solution, 375 mg of dry activated charcoal (while taking account of the amount of solvent contained in the pores of the solid). The resulting paper membrane with a diameter of 7 cm contains 75% w/w of activated charcoal, 12.5% w/w of softwood fibres and 12.5% of MFC.

Results—Paper Membrane Formulated with the Activated Charcoal Microparticles

FIGS. 24-27 compile the obtained results:

FIG. 24 shows the experimental X-ray diffractograms of the activated charcoal microparticles of Example 8 in the form of a paper membrane (curve (b) at the top, (microparticles grain size distribution) (λ_{Cu}˜1.5406 Å)), on the ordinate axis: arbitrary relative intensity (a.u.), on the abscissa axis: 2-theta (deg.);

FIG. 25 shows the thermogravimetric analysis (in air, heating rate of 5° C./minute) of the activated charcoal microparticles of Example 8 in the form of a paper membrane ((b) in grey). The mass loss Pm (in %) is represented as a function of the temperature T (in ° C., on the abscissa axis): on the ordinate axis=remaining mass (in %);

FIG. 26 shows the dinitrogen adsorption-desorption isotherms at 77K obtained after activation of the activated charcoal microparticles of Example 8 in the form of a paper membrane (points of the curve represented by squares) at 150° C. overnight, on the ordinate axis: N₂ volume (cm³·g⁻¹), on the abscissa axis: Relative Pressure (the black points correspond to the adsorption, the white points to the desorption; (nanoparticles grain size distribution) (P₀=1 atm.)) the obtained specific surface area BET of the activated charcoal paper membrane is 1,118 m²·g⁻¹+/−0.5;

FIG. 27b shows the image of the paper membrane containing 75% w/w of the activated charcoal microparticles of Example 8 obtained by scanning electron microscopy at a ×10,000 magnification.

Paper Membranes with the Zeolite Microparticles

### Example 24: Formulation of the Paper Membrane

The method for formulating the paper membrane is identical to that one described hereinbefore for the MIL-100(Fe) microparticles, by dispersing in an aqueous solution, 375 mg of dry zeolite (while taking account of the amount of solvent contained in the pores of the solid). The resulting paper membrane with a diameter of 7 cm contains 75% w/w of zeolite, 12.5% w/w of softwood fibres and 12.5% of MFC.

Results—Paper Membranes Formulated with the Zeolite Microparticles

FIGS. 21 to 23 compile the obtained results.

FIG. 21 shows the X-ray diffractograms of the NaY zeolite in the form of a paper membrane (curve (c) at the top), (microparticles grain size distribution) (λ_{Cu}˜1.5406 Å)), on the ordinate axis: arbitrary relative intensity (a.u.), on the abscissa axis: 2-theta (deg.); FIG. 22 shows the thermogravimetric analysis (in air, heating rate of 5° C./minute) of the NaY zeolite microparticles in the form of a paper membrane ((b) in grey). The loss of mass Pm (in %) is represented as a function of the temperature T (in ° C., on the abscissa axis): on the ordinate axis=remaining mass (in %);

FIG. 23 shows the dinitrogen adsorption-desorption isotherms at 77K obtained after activation of the powder NaY microparticles (points of the curve represented by circles) at 150° C. overnight, on the ordinate axis: volume N₂ (cm³·g⁻¹), on the abscissa axis: Relative Pressure (the black points correspond to the adsorption, the white points to the desorption; (nanoparticles grain size distribution) (P₀=1 atm.)). The obtained specific surface area BET of the zeolite paper membrane is 607 m²·g⁻¹+/−0.3;

### Part 7: Formulation of Monoliths Using Metal-Organic Frameworks Type Porous Solids.

This part aims to extend the previously proposed formulation process by increasing the thickness of the paper membrane in order to form a monolith. The characterizations of the textural properties of the MOFs powders and of the monoliths have been performed by carbon dioxide CO₂ adsorption porosimetry at 298K or with a Triflex® apparatus from Micromeritics™ when the maximum pressure was 1 bar either with an Intelligent Gravimetric Analyzer® (IGA) from Hiden Isoschema™ when the maximum pressure was 14 bar. The samples have been activated under primary vacuum using a Micromeritics® degasser overnight at temperatures comprised between 15° and 200° C. The CO₂ adsorption isotherm of the solids represents the adsorbed amount of gas (in mmol·g⁻¹) according to the pressure P of CO₂.

MIL-160(Al) or Al(OH)[C₄H₂O—(CO₂)₂]

### Example 25: Synthesis of the MIL-160(Al) Particles

4.8 g of 2,5-furandicarboxylic acid (30 mmol, C₆H₄O₅ commercialised by Sikemia®) and 4.6 g of aluminium acetate (30 mmol, Al(OH)(C₂H₃O₂)₂ commercialised by Alfa Aesar®) have been placed in a 100 ml round-bottomed flask and dispersed in 30 mL of distilled water. The mixture under stirring has been heated for 24 h at 120° C. The obtained white precipitate has been isolated by centrifugation and then washed with ethanol.

### Results

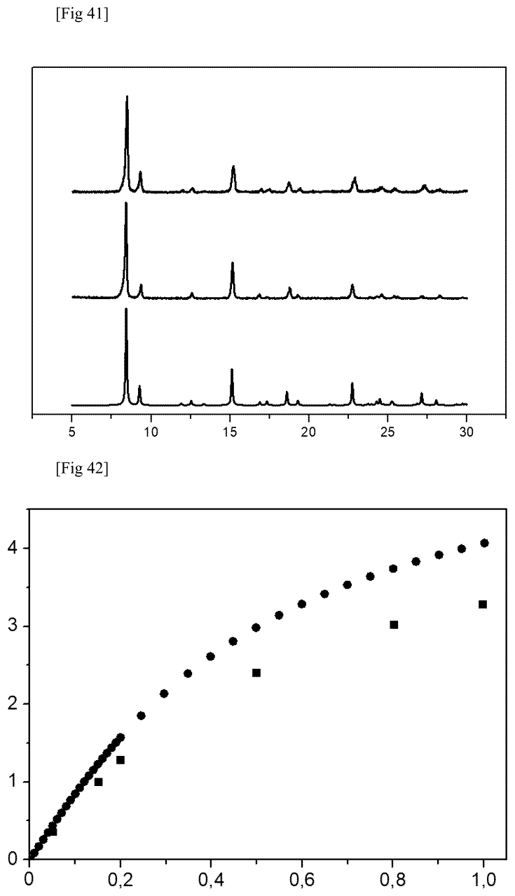

The results are summarised in FIGS. 41-42:

FIG. 41 shows the X-ray diffractograms of the simulated MIL-160(Al) solid (curve (a) at the bottom), experimental in the powder state (curve (b) at the middle, (nanoparticle grain size distribution) (λ_{Cu}≈1.5406 Å)), on the ordinate axis: arbitrary relative intensity (a.u.), on the abscissa axis: 2-theta (deg.);

FIG. 42 shows the carbon dioxide (CO₂) adsorption isotherm at 298K obtained after activation of the MIL-160(Al) powder (points of the curve represented by circles) at 150° C. overnight, on the ordinate axis: Amount of adsorbed CO₂ (mmol·g¹), on the abscissa axis: Pressure (the black points correspond to the adsorption); (nanoparticle grain size distribution) (Pₘₐₓ=1 bar.)).

Monolith with MIL-160(Al)

### Example 26: Formulation of the Monolith

187.5 mg of softwood pulp (HWBK™, bleached Kraft™ pulp supplied by Canson®) are inserted into a leaf mill with 20 mL of distilled water and then the fibres are ground for 2 minutes. 20 mL more are added to this suspension. The resulting fibre solution is passed to the ultrasound probe for 5 minutes in order to neatly separate the clusters of fibres. The equivalent of 187.5 mg of microfibrillated cellulose (MFC) (weighted mass of 6.25 g of MFC added because present at a mass concentration of 3% w/w, Celova® commercialised by Weidmann®) is inserted into the aqueous fibre solution and the mixture is stirred for 15 minutes. At the same time, the equivalent of 1.5 g of MIL-160 (Fe) nanoparticles (depending on the amount of solvent contained in the pores) is dispersed in an ultrasound bath in 30 mL of distilled water for 10 minutes. The suspension is added to the fibrous solution and stirred for 30 minutes (300 rpm). The mixture is filtered on a paper filter. The resulting paper membrane with a diameter of 3 cm and a thickness of about 0.8 cm contains 80% w/w of MIL-160(Al), 10% w/w of resin fibres and 10% w/w of MFC.

### Results

The results are summarised in FIGS. 41-42:

FIG. 41 shows the X-ray diffractograms of the simulated MIL-160(Al) solid (curve (c) at the top), (λ_{Cu}≈1.5406 Å)), on the ordinate axis: arbitrary relative intensity (a.u.), on the abscissa axis: 2-theta (deg.);

FIG. 42 shows the carbon dioxide (CO₂) adsorption isotherm at 298K obtained after activation of the MIL-160(Al) monolith (points of the curve represented by squares) at 150° C. overnight, on the ordinate axis: Adsorbed amount of CO₂ (mmol·g⁻¹), on the abscissa axis: Pressure (the black points correspond to the adsorption); (nanoparticle grain size distribution) (Pₘₐₓ=1 bar.)).

MIL-53(Al) or Al(OH)(C₆O₄)

### Example 27: Synthesis of the MIL-53(Al) Particles

13.3 g of hexadecahydrated aluminium sulphate (20 mmol, AAl₂(SO₄)₃·16H₂O sold by Alfa Aesar®), 3.3 g of 1,4-benzenedicarboxylic acid (20 mmol, 1,4-BDC, C₈H₆O₄ commercialised by Tokyo Chemical Industries®) and 1.2 g of urea (20 mmol, CO(NH₂)₂, commercialised by Alfa Aesar®) have been placed in a 100 mL round-bottomed flask and dispersed in 40 mL of distilled water. The mixture under stirring has been heated for 24 h at 120° C. The obtained precipitate has been isolated by filtration and then washed with water. The solid has been dried at room temperature overnight before calcination. The powder has been calcined at 330° C. for 33 h.

### Results

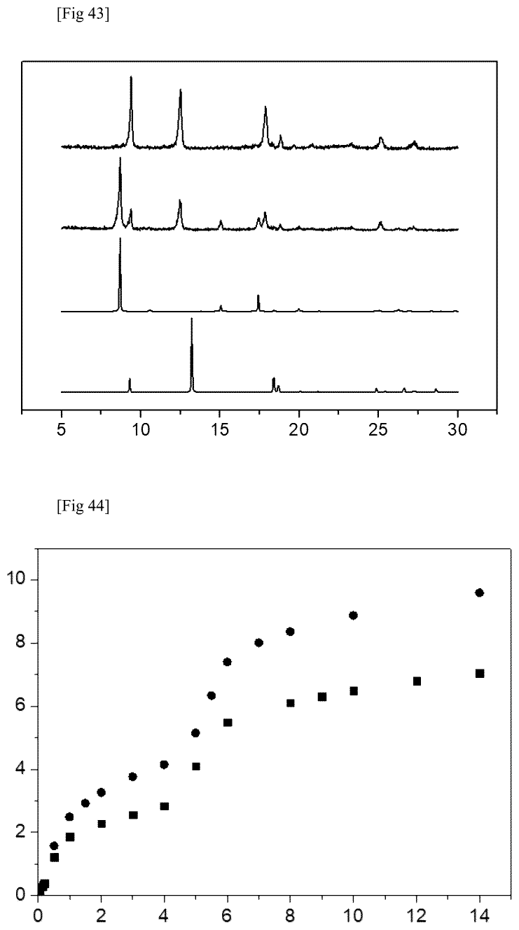

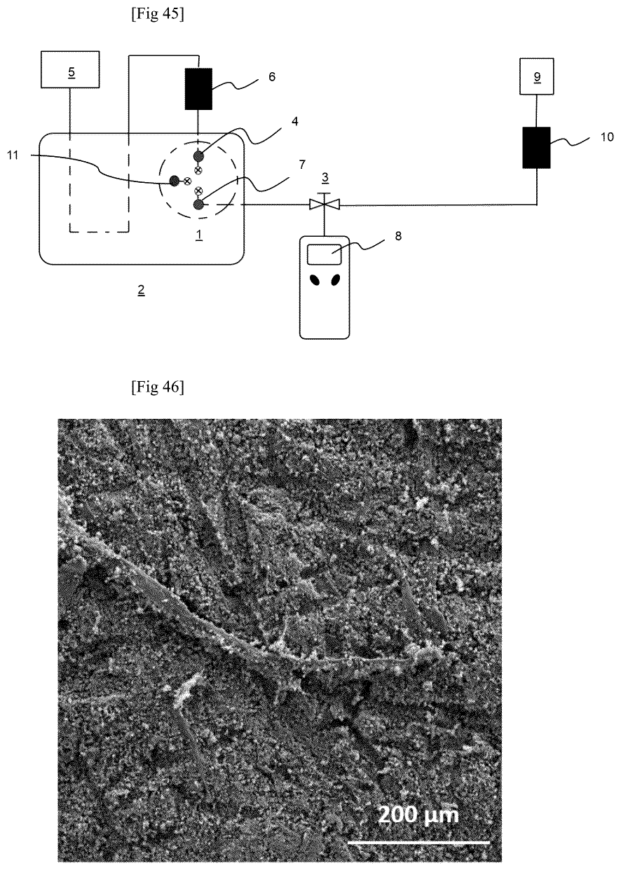

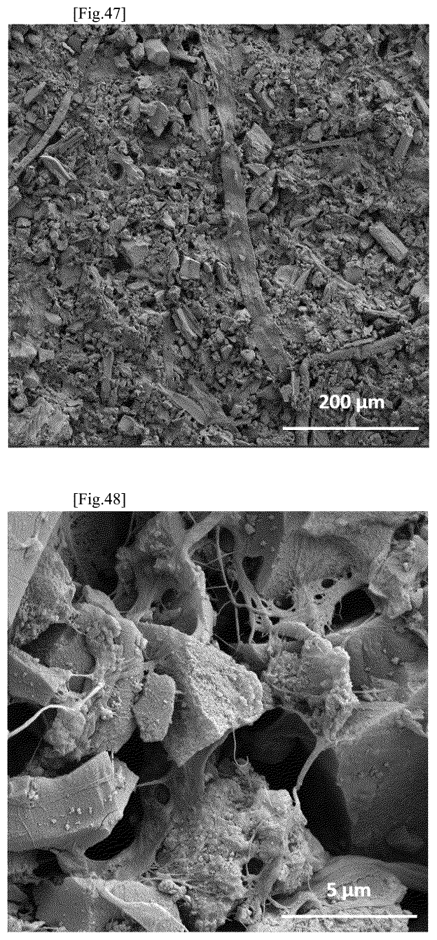

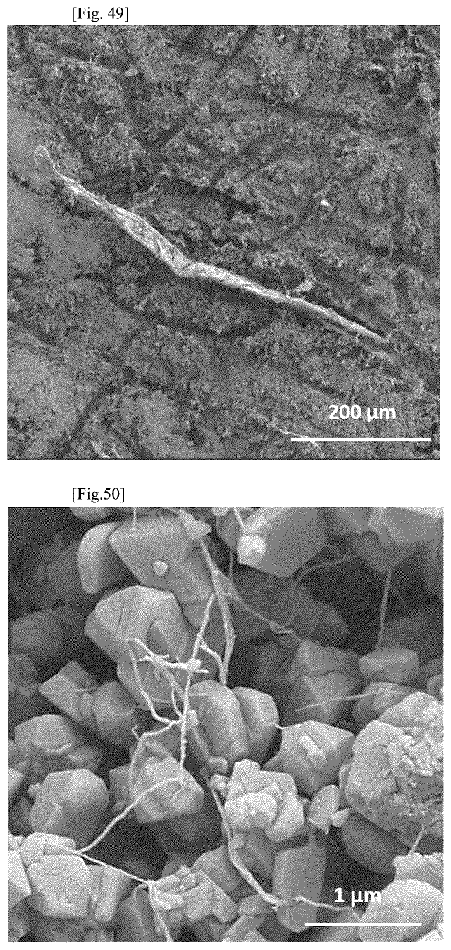

The results are summarised in FIGS. 43-44:

FIG. 43 shows the X-ray diffractograms of the solid MIL-53(Al) simulated according to the different pore sizes (curve (a) at the bottom), experimental in the powder state (curve (b) at the middle, (microparticle grain size distribution) (λ_{Cu}≈1.5406 Å)), on the ordinate axis: arbitrary relative intensity (a.u.), on the abscissa axis: 2-theta (deg.);

FIG. 44 shows the carbon dioxide (CO₂) adsorption isotherm at 298K obtained after activation of the MIL-53(Al) powder (points of the curve represented by circles) at 200° C. overnight, on the ordinate axis: Amount of adsorbed CO₂ (mmol·g⁻¹), on the abscissa axis: Pressure (the black points correspond to the adsorption); (microparticles grain size distribution) (Pₘₐₓ=14 bar.)).

Monolith with MIL-53(Al)

### Example 28: Formulation of the Monolith

The process for formulating the monolith is identical to that one described hereinbefore for the MIL-160(Al) nanoparticles, by dispersing in an aqueous solution, 1.5 g of MIL-53(Al) (while taking account of the amount of solvent contained in the pores of the solid). The resulting monolith with a diameter of 3 cm and a thickness of about 0.8 cm contains 80% w/w of MIL-53(Al), 10% w/w of resin fibres and 10% w/w of MFC.

### Results

The results are summarised in FIGS. 43-44:

FIG. 43 shows the X-ray diffractograms of the simulated solid MIL-53(Al) (curve (c) at the top), (λ_{Cu}≈1.5406 Å)), on the ordinate axis: arbitrary relative intensity (au), on the abscissa axis: 2-theta (deg.);

FIG. 44 shows the carbon dioxide (CO₂) adsorption isotherm at 298K obtained after activation of the MIL-53(Al) monolith (points of the curve represented by squares) at 200° C. overnight, on the ordinate axis: Adsorbed amount of CO₂ (mmol·g¹), on the abscissa axis: Pressure (the black dots correspond to adsorption); (microparticles grain size distribution) (Pₘₐₓ=14 bar.)).

### Part 8: Test for Capturing the VOCs by the Paper Membranes

This part shows the efficiency of capture of some pollutants that might be present in patrimonial institutions and deleterious for collection objects as well as for the health of the individuals.

A setup allowing carrying out trapping of the organic pollutants is carried out in order to quantify the capacity of the paper membranes to adsorb these vapours. This setup, shown in FIG. 45, comprises a chamber 1 with a volume of 0.5 dm³, placed in a thermostatically-controlled bath 2 (T=25° C.). The thermostatically-controlled bath 2 comprises three distinct inlets, each could be opened or closed using a valve 3. A first inlet 4 forms the intake of the outside air 5 passing through a first activated charcoal filter 6 in order to guarantee pure air during the measurement. A second inlet 7 ensures the link between the chamber and the measuring instrument, a photo-ionisation PID detector 8 (PID ppbRAE 3000+™ commercialised by Honeywell®). Air from laboratory 9 filtered by a second activated charcoal filter 10. The detector 8 allows accurately detecting the VOCs at concentrations ranging from 1 ppb to 15,000 ppm. Thus, thanks to this apparatus, it is possible to quantify the presence of VOCs in the chamber during the conducted experiments and thus to be able to compare the effectiveness of the tested adsorbents. A third inlet 11 includes an injection lid which enables the injection of the VOC using a syringe (V_{injected}=1 μL).

A measurement may be done with or without adsorbent in order to be able to experimentally estimate the adsorption capacity of each material. The measurement is split into three steps:
a) the PID detector 8 is turned on in order to make filtered air circulate in the chamber 1 until it no longer detects the compound. The three inlets 4, 7, 11 of the chamber 1 are then closed;
b) a volume of 1 μL of VOC is injected into the chamber 1, and left for 30 minutes for homogenisation;
c) the amount of VOC is measured using the PID detector 8, this amount decreases throughout the measurement until reaching 0 ppm because the detector purges the container at a rate of 0.5 L·min⁻¹.

In the presence of an adsorbent, steps a-c are carried out, and 50 mg of one of the composites prepared in Part 5 are inserted beforehand into the chamber. The surface covered by the VOC concentration curve as a function of time during the purging reflects the amount of pollutant present in the container. The calculation of the ratio of the surfaces obtained with and without an adsorbent composite allows deducing the effective adsorption percentage.

### Formic Acid Capture

The analysed VOC is herein formic acid and the paper membranes formulated (part 6) from MIL-100(Fe) microparticles, activated charcoal and zeolite have been tested.

### Results—Capture Tests

Table 14 shows the obtained results.

Table 14 summarises the obtained results corresponding (a) to the purge time necessary to reach 0 ppm, (b) to the maximum formic acid concentration detected by the PID and (c) to the equivalent formic acid volumes detected (L) by the PID in the presence, or not, of an adsorbent for 1 μL injected as well as to the deduction of the adsorption capacities

TABLE 14

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| “White” | Test 1 | 8.5 | 257.1 | 1 | |
| Acid | Test 2 | 8.5 | 242.1 | 1 | |
| formic | Test 3 | 9.5 | 276.4 | 1 | |
| | Average | 8.8 | 258.5 | 1 | |
| Activated | Test 1 | 14 | 7.3 | 0.04 | 95.6% +/− |
| charcoal | Test 2 | 33 | 11.1 | 0.05 | 0.7 |
| (A) | Test 3 | 44 | 6.7 | 0.04 | |
| | Average | 30.3 | 8.4 | 0.04 | |
| Zeolite | Test 1 | 30 | 9.5 | 0.11 | 90% +/− |
| (B) | Test 2 | 51 | 12.5 | 0.08 | 0.6 |
| | Test 3 | 50.5 | 13.8 | 0.1 | |
| | Average | 43.8 | 11.9 | 0.1 | |
| MIL-100(Fe) | Test 1 | 25.5 | 5.5 | 0.03 | 97% +/− |
| (C) | Test 2 | 18 | 7 | 0.03 | 0.5 |
| | Test 3 | 31 | 5 | 0.03 | |
| | Average | 24.8 | 5.8 | 0.03 | |

Table 14 summarises the data inherent to the adsorption measurements carried out in the presence, or not, of the different composites (zeolite activated charcoal and MIL-100(Fe)), their average as well as to the average percentages of formic acid adsorption for each composite.

### Acetic Acid Capture

The analysed VOC is herein acetic acid, cellulose paper and the paper membranes formulated (cf. part 6) from microparticles of MIL-100(Fe), MIL-127(Fe), activated charcoal and zeolite have been tested.

### Results—Capture Tests

Table 15 shows the obtained results.

Table 15 summarises the obtained results corresponding (a) to the purge time necessary to reach 0 ppm, (b) to the maximum acetic acid concentration detected by the PID and (c) to the equivalent acetic acid volumes detected (L) by the PID in the presence, or not, of an adsorbent for 1 μL injected as well as to the deduction of the adsorption capacities.

TABLE 15

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| “White” | Test 1 | 10 | 725.5 | 1 | |
| Acid | Test 2 | 11 | 659.4 | 1 | |
| Acetic | Test 3 | 12.5 | 723.8 | 1 | |
| | Average | 11.2 | 702.9 | 1 | |
| Paper | Test 1 | 7 | 396.1 | 0.63 | 32.6% +/− |
| cellulose | Test 2 | 6.5 | 348.1 | 0.62 | 3.4 |
| (A) | Test 3 | 7.5 | 372.4 | 0.58 | |
| | Average | 7 | 372.2 | 0.61 | |
| Charcoal | Test 1 | 10.5 | 28.5 | 0.04 | 95.9% +/− |
| Activated | Test 2 | 13.5 | 33.4 | 0.04 | 0.5 |
| (B) | Test 3 | 12 | 24 | 0.04 | |
| | Average | 12 | 28.6 | 0.04 | |
| Zeolite | Test 1 | 31 | 71.3 | 0.16 | 86% +/− |
| (C) | Test 2 | 24.5 | 67.6 | 0.12 | 1.5 |
| | Test 3 | 42.5 | 64.2 | 0.14 | |
| | Average | 32.7 | 67.7 | 0.14 | |
| MIL-100(Fe) | Test 1 | 15.5 | 15.6 | 0.03 | 97% +/− |
| (D) | Test 2 | 21.5 | 14.1 | 0.03 | 0.3 |
| | Test 3 | 23 | 13.4 | 0.03 | |
| | Average | 20 | 14.4 | 0.03 | |
| MIL-127(Fe) | Test 1 | 17 | 17.5 | 0.04 | 96.3% +/− |
| (E) | Test 2 | 17 | 14.7 | 0.04 | 0.2 |
| | Test 3 | 12.5 | 17 | 0.04 | |
| | Average | 15.5 | 49.2 | 0.04 | |

Table 15 summarises the data inherent to the adsorption measurements carried out in the presence, or not, of the cellulose paper or of the different composites (zeolite activated charcoal, MIL-100(Fe) and MIL-127(Fe)) and their average as well as to the average percentages of acetic acid adsorption for each composite.

### Acrylic Acid Capture

The analysed VOC is herein acrylic acid, cellulose paper and the paper membranes formulated (cf. part 6) from microparticles of MIL-100(Fe), activated charcoal and zeolite have been tested.

### Results—Capture Tests

Table 16 shows the obtained results.

Table 16 summarises the results obtained (a) at the purge time necessary to reach 0 ppm, (b) at the maximum acrylic acid concentration detected by the PID and (c) at the equivalent acrylic acid volumes detected (L) by the PID in the presence, or not, of an adsorbent for 1 μL injected as well as to the deduction of the adsorption capacities.

TABLE 16

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| “White” | Test 1 | 34.5 | 418.7 | 1 | |
| Acid | Test 2 | 14.5 | 342.7 | 1 | |
| Acrylic | Test 3 | 17 | 339 | 1 | |
| | Average | 22 | 366.8 | 1 | |
| Paper | Test 1 | 12.5 | 335.6 | 0.79 | 22.7% +/− |
| cellulose | Test 2 | 13 | 347.9 | 0.77 | 3.6 |
| (A) | Test 3 | 13 | 374.8 | 0.78 | |
| | Average | 12.8 | 352.8 | 0.78 | |
| Charcoal | Test 1 | 23.5 | 18.9 | 0.05 | 94.9% +/− |
| Activated | Test 2 | 7 | 22.3 | 0.04 | 0.6 |
| (B) | Test 3 | 19 | 21.8 | 0.05 | |
| | Average | 16.5 | 21 | 0.05 | |
| Zeolite | Test 1 | 20.5 | 85.8 | 0.19 | 80.7% +/− |
| (C) | Test 2 | 27.5 | 87.2 | 0.22 | 2.3 |
| | Test 3 | 31 | 73.8 | 0.17 | |
| | Average | 26.3 | 82.3 | 0.19 | |
| MIL-100(Fe) | Test 1 | 6.5 | 21.2 | 0.05 | 95.6% +/− |
| (D) | Test 2 | 8 | 20.2 | 0.04 | 0.7 |
| | Test 3 | 8.5 | 13.7 | 0.04 | |
| | Average | 7.7 | 18.4 | 0.04 | |

Table 16 summarises the data inherent to the adsorption measurements carried out in the presence, or not, of the cellulose paper or of the different composites (zeolite activated charcoal, MIL-100(Fe)) and their average as well as to the average percentages of acrylic acid adsorption for each composite.

### Furfural Capture

The analysed VOC is herein furfural, cellulosic paper and the paper membranes formulated (cf. part 6) from Al-PDA nanoparticles as well as microparticles of MIL-100(Fe), activated charcoal and zeolite have been tested.

### Results—Capture Tests

Table 17 shows the obtained results.

Table 17 summarises the results obtained (a) at the purge time necessary to reach 0 ppm, (b) at the maximum furfural concentration detected by the PID and (c) at the equivalent furfural volumes detected (μL) by the PID in the presence, or not, of an adsorbent for 1 μL injected as well as to the deduction of the adsorption capacities as well as to the deduction of the adsorption capacities.

TABLE 17

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| “White” | Test 1 | 31.5 | 187.1 | 1 | |
| Furfural | Test 2 | 39.5 | 206.2 | 1 | |
| | Test 3 | 22.5 | 155.3 | 1 | |
| | Average | 31.2 | 148.3 | 1 | |
| Paper | Test 1 | 42 | 82.3 | 0.8 | 22.2% +/− |
| cellulose | Test 2 | 44.5 | 113.8 | 0.78 | 4.9 |
| (A) | Test 3 | 36 | 128.2 | 0.76 | |
| | Average | 40.8 | 108.1 | 0.78 | |
| Charcoal | Test 1 | 26.5 | 20.7 | 0.12 | 88.8% +/− |
| Activated | Test 2 | 73.5 | 17.6 | 0.13 | 1.9 |
| (B) | Test 3 | 95 | 20.5 | 0.13 | |
| | Average | 65 | 19.6 | 0.13 | |
| Zeolite | Test 1 | 113 | 63 | 0.89 | 11.8% +/− |
| (C) | Test 2 | 97.5 | 73.7 | 0.86 | 5.5 |
| | Test 3 | 120 | 68.6 | 0.89 | |
| | Average | 110.2 | 68.4 | 0.88 | |
| Al-PDA | Test 1 | 46.5 | 22.5 | 0.16 | 85% +/− |
| (D) | Test 2 | 56.5 | 22.6 | 0.12 | 2.4 |
| | Test 3 | 103.5 | 25.8 | 0.17 | |
| | Average | 68.8 | 23.6 | 0.15 | |
| MIL-100(Fe) | Test 1 | 22 | 1.1 | 0.009 | 99% +/− |
| (E) | Test 2 | 34 | 0.9 | 0.008 | 0.15 |
| | Test 3 | 60.5 | 1 | 0.01 | |
| | Average | 38.8 | 1 | 0.009 | |

Table 17 summarises the data inherent to the adsorption measurements carried out in the presence, or not, of the cellulose paper or of the different composites (zeolite activated charcoal, Al-PDA and MIL-100(Fe)) and their average as well as to the average percentages of furfural adsorption for each composite.

The conditions of the VOCs capture tests have been slightly modified by increasing the time of contact between the VOC and the composite from 30 minutes to 1 h30 and by dividing the mass of composite inserted into the chamber by 10 (now 5 mg). The injected volume is left constant (V=1 μL).

### Acetic Acid Capture

The analysed VOC is herein acetic acid and the paper membranes formulated (cf. part 6) from MIL-100(Fe) microparticles, and activated charcoal have been tested.

### Results—Capture Tests

Table 18 shows the obtained results.

Table 18 summarises the obtained results corresponding (a) to the purge time necessary to reach 0 ppm, (b) to the maximum acetic acid concentration detected by the PID and (c) to the equivalent acetic acid volumes detected (L) by the PID in the presence of an adsorbent for 1 μL injected as well as to the deduction of the adsorption capacities.

TABLE 18

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| Charcoal | Test 1 | 5.5 | 138.1 | 0.2 | 74% +/− |
| Activated | Test 2 | 7.5 | 167 | 0.24 | 2.7 |
| | Test 3 | 6.5 | 160.7 | 0.26 | |
| | Average | 6.5 | 155.3 | 0.23 | |
| MIL-100(Fe) | Test 1 | 4.5 | 39.7 | 0.06 | 94% +/− |
| | Test 2 | 4 | 37 | 0.05 | 0.6 |
| | Test 3 | 4.5 | 36 | 0.06 | |
| | Average | 4.3 | 37.7 | 0.06 | |

Table 18 summarises the data inherent to the adsorption measurements carried out in the presence of the different composites (zeolite activated charcoal, MIL-100(Fe) and MIL-127(Fe)) and their average as well as to the average percentages of acetic acid adsorption for each composite.

### Acrylic Acid Capture

The analysed VOC is herein acrylic acid and the paper membranes formulated (cf. part 6) from MIL-100(Fe) microparticles, and activated charcoal have been tested.

### Results—Capture Tests

Table 19 shows the obtained results.

Table 19 summarises the results obtained (a) at the purge time necessary to reach 0 ppm, (b) at the maximum acrylic acid concentration detected by the PID and (c) at the equivalent acrylic acid volumes detected (L) by the PID in the presence of an adsorbent for 1 μL injected as well as to the deduction of the adsorption capacities.

TABLE 19

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| Charcoal | Test 1 | 7 | 82.2 | 0.19 | 82% +/− |
| Activated | Test 2 | 6 | 82.2 | 0.16 | 0.7 |
| | Test 3 | 7 | 85.7 | 0.18 | |
| | Average | 6.7 | 83.4 | 0.18 | |
| MIL-100(Fe) | Test 1 | 5 | 22 | 0.05 | 96% +/− |
| | Test 2 | 4 | 17.6 | 0.03 | 1.8 |
| | Test 3 | 4.5 | 20 | 0.04 | |
| | Average | 4.5 | 19.9 | 0.04 | |

Table 19 summarises the data inherent to the adsorption measurements carried out in the presence of the different composites (zeolite activated charcoal, MIL-100(Fe)) and their average as well as to the average percentages of acrylic acid adsorption for each composite.

### Furfural Capture

The analysed VOC is herein furfural, cellulosic paper and the paper membranes formulated (cf. part 6) from Al-PDA nanoparticles as well as microparticles of activated charcoal and MIL-100(Fe) have been tested.

### Results—Capture Tests

Table 20 shows the obtained results.

Table 20 summarises the results obtained (a) at the purge time necessary to reach 0 ppm, (b) at the maximum furfural concentration detected by the PID and (c) at the equivalent furfural volumes detected (L) by the PID in the presence of an adsorbent for 1 μL injected as well as the deduction of the adsorption capacities as well as the deduction of the adsorption capacities.

TABLE 20

| | | | | Detected | |
|---|---|---|---|---|---|
| | | | | total | |
| | | Purge | Maximum | equivalent | Adsorption |
| | | time | concentration | volume | capacity |
| | | (min) | (ppm) | (μL) | (%) |
| Charcoal | Test 1 | 310.5 | 18.9 | 0.25 | 76.7% +/− |
| Activated | Test 2 | 300 | 19.2 | 0.24 | 2 |
| | Test 3 | 290.5 | 20.4 | 0.22 | |
| | Average | 300.3 | 19.5 | 0.24 | |
| Al-PDA | Test 1 | 35.5 | 50.9 | 0.3 | 71.3% +/− |
| | Test 2 | 38 | 51.3 | 0.28 | 1.9 |
| | Test 3 | 31 | 41.5 | 0.28 | |
| | Average | 34.8 | 47.9 | 0.28 | |
| MIL-100(Fe) | Test 1 | 251.5 | 7.8 | 0.07 | 92.7% +/− |
| | Test 2 | 207.5 | 8.8 | 0.08 | 0.7 |
| | Test 3 | 211.5 | 7 | 0.08 | |
| | Average | 223.5 | 7.9 | 0.08 | |

Table 20 summarises the data inherent to the adsorption measurements carried out in the presence of the different composites (activated charcoal, Al-PDA and MIL-100(Fe)) and their average as well as to the average percentages of furfural adsorption for each composite.
Part 9: Test of Release of the Paper Membranes after Capture of VOCs

The objective of this part is the study of the release by the different paper membranes after capture of pollutants (the pollutants studied in part 8).

VOCs release

After the capture tests, the paper membranes have been placed independently in closed flasks (500 cm³) for 24 h in the presence of a passive diffusion tube (commercialised by GASTEC) in order to quantify the amount of pollutant emitted by the composite.

### Results—Release Tests

Tables 21-24 compile the obtained data.

Table 21 relates to the formic acid concentration detected in the flask showing the potentials released by the paper membrane after capture.

TABLE 21

| | Activated Charcoal | NaY zeolite | MIL-100(Fe) |
|---|---|---|---|
| Formic acid | 3.3 ppm | 4.16 ppm | 0 ppm |
| concentration | | | (140 ppb detected |
| measured after 24 | | | after 72 h) |
| h in the flask | | | |

Table 21 summarises the formic acid concentrations measured after 24 h in the flask in the presence of the paper membrane formulated from NaY zeolite, activated charcoal or MIL-100(Fe).

Table 22 relates to the acetic acid concentration measured in the flask showing the potentials released by the paper membrane after capture.

TABLE 22

| | Activated Charcoal | NaY zeolite | MIL-100(Fe) |
|---|---|---|---|
| Acetic acid | 0.75 ppm | >5 ppm | 0 ppm |
| concentration | | | |
| measured after 24 | | | |
| h in the flask | | | |

Table 22 summarises the acetic acid concentrations measured after 24 h in the flask in the presence of the paper membrane formulated from NaY zeolite, activated charcoal or MIL-100(Fe).

Table 23 relates to the acrylic acid concentrations measured in the flask showing the potentials released by the paper membrane after capture.

TABLE 23

| | Activated Charcoal | NaY zeolite | MIL-100(Fe) |
|---|---|---|---|
| Acrylic acid | 0.42 ppm | 3.4 ppm | 0 ppm |
| concentration | | | |
| measured after 24 | | | |
| h in the flask | | | |

Table 23 summarises the acrylic acid concentrations measured after 24 h in the flask in the presence of the paper membrane formulated from NaY zeolite, activated charcoal or MIL-100(Fe).

Table 24 relates to the furfural concentrations measured in the flask showing the potentials released by the paper membrane after capture.

TABLE 24

| | Activated Charcoal | Al-PDA | MIL-100(Fe) |
|---|---|---|---|
| Furfural | 0.21 ppm | 0 ppm | 0 ppm |
| concentration | | | |
| measured after 24 | | | |
| h in the flask | | | |

Table 24 summarises the furfural concentrations measured after 24 h in the flask in the presence of the paper membrane formulated from activated charcoal, Al-PDA or MIL-100(Fe).

### REFERENCES

The following table lists the references cited before in the text:

TABLE 21

| | |
|---|---|
| 1 | EP3453450 (A1) |
| 2 | D. Klemm et al. Nanocelluloses: A new family of nature-based materials. |
| | Angew. Chem. Int. Ed. 50, 5438-5466. 2011. |
| 3 | H. Kargarzadeh, M. Mariano, D. Gopakumar, I. Ahmad, S. Thomas, A. |
| | Dufresne, J. Huang, H. Lin. Advances in cellulose nanomaterials. Cellulose. |
| | 25, 2151-2189. 2018. |
| 4 | J. Rouquerol et al., “Recommendations for the characterisation of porous |
| | solids (Technical Report)”, Pure & Appl. Chem, vol. 66, 1994, p. 1739-1758 |
| 5 | Rouquerol, F.; Rouquérol, J.; Sing, K. Adsorption by powders and porous |
| | solids; Academic Press: San Diego, 1999. |
| 6 | L. Sarkisov et A. Harrison, Mol. Simul., 2011, 37, 1248-1257 |
| 7 | R. S. Pillai, F. Nouar, J. Pires, N. Steunou, E. Dumas, G. Maurin, C. Serre, |
| | M. L. Pinto. “Metal-Organic Frameworks for Cultural Heritage |
| | Preservation: The Case of Acetic Acid Removal” ACS. Appl. Mater. |
| | Interfaces. 2018, 10, 16, 13886-13894. |
| 8 | V. Benoit, R. S. Pillai, A. Orsi, P. Normand, H. Jobic, F. Nouar, P. |
| | Billemond, E. Bloch, S. Bourrelly, T. Devic, P. A. Wright, G. de Weireld, C. |
| | Serre, G. Maurin, P. L. LLewellyn. MIL-91(Ti), “a small pore metal-organic |
| | framework which fulfils several criteria: an upscaled green synthesis, |
| | excellent water stability, high CO2 selectivity and fast CO2 transport”. |
| | J. Mater. Chem. A. 2016, 4, 1383-1389. |
| 9 | J-B. Lin, T. T. T. Nguyen, R. Vaidhyanathan, J. Burner, J. M. Taylor, H. |
| | Durekova, F. Akhtar, R. K. Mah, O. Ghaffari-Nik, S. Marx, N. Fylstra, S. S. |
| | Iremonger, K. W. Dawson, P. Sarkar, P. Hovington, A. Rajendran, T. K. |
| | Woo, G. K. H. Shimizu. “A scalable metal-organic framework as a durable |
| | physisorbent for carbon dioxide capture”, Science. 2021, 374, 1464-1469. |
| 10 | R-B. Lin, L. Li, H-L. Zhou, H. Wu, C. He, S. Li, R. Krishna, J. Li, W. Zhou, |
| | B. Chen. “Molecular sieving of ethylene frome thane using a rigid metal- |
| | organic framework” Nature Materials. 2018, 17, 1128-1133. |
| 11 | M. T. Kapelewski, S. J. Geier, M. R. Hudson, D. Stück, J. A. Mason, J. N. |
| | Nelson, D. J. Xiao, Z. Hulvey, E. Gilmour, S. A. FitzGerald, M. Head- |
| | Gordon, C. M. Brown, J. R. Long. “M2(m-dobdc) (M = Mg, Mn, Fe, Co, Ni) |
| | Metal-Organic Frameworks Exhibiting Increased Charge Density and |
| | Enhanced H2 binding at the Open Metal Sites” JACS. 2014, 136, 34, 12119- |
| | 12129. |
| 12 | S. Wang, M. Wahiduzzaman, L. Davis, A. Tissot, W. Shepard, J. Marrot, C. |
| | Martineau-Corcos, D. Hamdane, G. Maurin, S. Devautour-Vinot, C. Serre. |
| | “A robust zirconium amino acid metal-organic framework for proton |
| | conduction” Nature Commun. 2018, 9, 4937. |
| 13 | F. Fathieh, M. J. Kalmutzki, E. A. Kapustin, P. J. Waller, J. Yang, O. M. |
| | Yaghi. “Practical water production from desert air” Sci. Adv. 2018, 4. |
| 14 | A. Permyakova, S. Wang, E. Courbon, F. Nouar, N. Heymans, P. D'Ans, N. |
| | Barrier, P. Billemont, G. De Weireld, N. Steunou, M. Frere, C. Serre. |
| | “Design of salt-metal organic framework composites for seasonal heat |
| | storage applications” J. Mater. Chem. A. 2017, 5, 12889-12898. |
| 15 | https://doi.org/10.26434/chemrxiv.12924719.v1, Sep. 8, 2020 Version 1 |
| 16 | US20210277042 (A1) |
| 17 | WO2016186454 (A1) |
| 18 | A. Ghorbanpour, L. D. Huelsenbeck, D-M. Smilgies, G. Giri. Cryst. Eng. |
| | Comm. “Oriented thin films through solution shearing”, 2018, 20, 294-300. |
| 19 | WO2019053048 (A1) |
| 20 | PR-NF-Z40-016. Information et documentation-Papiers et cartons de |
| | conservation-Mesures de l'impact des materiaux de conservation sur la |
| | cellulose du papier. AFNOR CN46-10. |
| 21 | IEC-CEI 60450. Measurement of the average viscosimetric degree of |
| | polymerization of new and aged cellulosic electrically insulating materials. |
| | 2007. |

1. A method for preparing a porous membrane comprising the following steps of:
a) preparing an aqueous mixture comprising a dispersion of fibers derived from an organic material in water, a nanoscale structuring agent comprising cellulose microfibrils and porous solid particles suspended in water;
b) stirring the aqueous mixture for at least 10 min at room temperature;
c) vacuum filtering the aqueous mixture and recovering a composite material; and
d) pressing the composite material obtained in step to form a porous membrane;
wherein the porous solid particles are selected from at least one of the following particles: a zeolite particle, an activated carbon particle, and a structured metal-organic compound (MOF), wherein the MOF comprises polydentate chelating ligands; and are present in a content greater than or equal to 55% with respect to the total mass of the obtained porous membrane.

2. The method according to claim 1, wherein the fibers are biosourced fibres.

3. The method according to claim 1, wherein the cellulose microfibrils are 0.5 to 50 μm in length.

4. A porous membrane obtained according to the method of claim 1 for the capture of volatile organic compounds (VOCs), comprising:
50-85% of a porous solid particle;
15-50% of a cellulose matrix;
the percentages being mass percentages relative to the total mass of the porous membrane; the porous solid particle being selected from at least one of the following particles: a zeolite particle, an activated charcoal particle, and a structured metal-organic compound (MOF), wherein the MOF comprises polydentate chelating ligands.

5. The porous membrane according to claim 4, wherein the porous solid particle is an MOF particle present in a content of 55 to 80% relative to the total mass of the porous membrane.

6. The porous membrane according to claim 4, wherein the MOF particle comprises at least one metal selected from Cu, Zn, Ca, Ln, Y, Mg, Ti, Zr, V, Cr, Mn, Fe and/or Al.

7. The porous membrane according to claim 4, wherein the polydentate chelating ligand comprises C6-C24 aromatic compounds comprising at least one carboxylic acid function.

8. The porous membrane according claim 4, wherein the porous solid particle comprises at least one of nanoparticles and/or microparticles with a diameter of 50 nm to 80 μm.

9. The porous membrane according to claim 4, wherein the MOF is selected from MIL-100(Fe), MIL-127(Fe), Ca-Squarate, Al-PDA, MIP-202(Zr), MIL-91(Ti), UiO-66(Zr)-2CF3, MIL-53(Al)-CF3, CALF-20, or ZIF-8.

10. The porous membrane according to claim 4, wherein the thickness of the membrane is 150-500 μm.

11. A method for purifying ambient air or purifying a storage space containing VOC-sensitive objects comprising using the porous membrane of claim 4.

12. A method for capturing CO2 in ambient air or in an industrial environment, separating gases, storing gases, for proton conductivity in sustainable energy systems, for treating air by water adsorption for dehumidification, fresh water production, air-conditioning or heating or decontaminating exhaust gases of an engine comprising NOx comprising using the porous membrane of claim 4.

13. The method according to claim 1, wherein the fibers are cellulose fibers.

14. The porous membrane according to claim 4, wherein the MOF particle comprises at least one metal ion selected from Fe, Al and/or Zr.

15. The porous membrane according to claim 4, wherein the polydentate chelating ligand is selected from at least one of benzene-1,3,5-tricarboxylic acid, 3,3′,5,5′-azobenzenetetracarboxylic acid, 3,5-pyrazoledicarboxylic acid, 2,5-bistrifluoromethyl-1,4-benzenedicarboxylic acid, 2-(trifluoromethyl)-1,4-benzenedicarboxylic acid, 1,2,4-triazole, 2-methylimidazole, N,N′-piperazine(methylenephosphonic) acid, L-aspartic acid, 2,5-dihydroxydeterephthalic acid, and/or 3,4-dihydroxy-3-cyclobutene-1,2-dione.
